(19) United States
(12) Patent Application Publication
(10) Pub. No.: US 2025/0104404 A1
(43) Pub. Date: Mar. 27, 2025

(54) INDIVIDUALIZED GENERATIVE MODELS FOR IMAGE GENERATION AND MANIPULATION

(71) Applicant: The University of Chicago, Chicago, IL (US)

(72) Inventors: Alexander Todorov, Chicago, IL (US); Stefan D. Uddenberg, Chicago, IL (US); Daniel N. Albohn, Chicago, IL (US)

(21) Appl. No.: 18/900,073

(22) Filed: Sep. 27, 2024

Related U.S. Application Data
(60) Provisional application No. 63/540,871, filed on Sep. 27, 2023.

(51) Int. Cl. G06V 10/774; G06V 10/766; G06V 10/82; G06V 10/94

(52) U.S. Cl. CPC G06V 10/774; G06V 10/766; G06V 10/82; G06V 10/945

(57) ABSTRACT

Systems and methods are provided herein for training a customized model. A method of constructing a customized generative model, comprising reading a plurality of synthetic images and associated latent representations; presenting each of the plurality of synthetic images to one or more users via a client computing platform; reading a plurality of inputs characterizing a plurality of values for a plurality of associated attributes of each of the plurality of synthetic images; based on the values of the associated attributes and the latent representations, training a regression model to predict the values of the attributes from the latent representations.

### RELATED APPLICATION(S)

This application claims the benefit of priority to U.S. Provisional Application No. 63/540,871, filed Sep. 27, 2023, which is incorporated herein by reference in its entirety.

### BACKGROUND

Embodiments of the present disclosure relate to generative models based on human impressions, and more specifically, to individualized generative models for image generation and manipulation.

### BRIEF SUMMARY

According to embodiments of the present disclosure, methods of, and computer program products for constructing a customized generative model are provided.

In some embodiments a method of constructing a customized generative model, comprises reading a plurality of synthetic images and associated latent representations; presenting each of the plurality of synthetic images to one or more users via a client computing platform. The method may comprise reading a plurality of inputs to the client computing platform. The plurality of inputs may characterize a plurality of values for associated attributes of each of the plurality of synthetic images. The method may comprise, based on the values of the associated attributes and the latent representations, training a regression model to predict the values of the attributes from the latent representations.

In some embodiments, the method further comprises receiving target values for the plurality of attributes; using the regression model, determining a target latent representation corresponding to the target values; providing the target latent representation to a generative model and receiving therefrom an image embodying the target values for the plurality of attributes.

In some embodiments, each of the plurality of synthetic images was generated by a generative model based on its associated latent representation. In some embodiments, the method further comprises generating the plurality of synthetic images by a generative model.

In some embodiments, generating the plurality of synthetic images comprises selecting randomly from a latent space of the generative model. In some embodiments, the generative model is pretrained on a single object type. In some embodiments, the generative model is trained using a training dataset comprising neutral-appearing images.

In some embodiments, the method further comprises generating the associated latent representation of each synthetic image by providing the synthetic image to an encoder. In some embodiments, the encoder comprises an artificial neural network. In some embodiments, the plurality of synthetic images is presented to exactly one user, thereby customizing the regression model to the exactly one user. In some embodiments, the plurality of synthetic images is presented to a plurality of users, thereby customizing to a group comprising the plurality of users.

In some embodiments, each value is selected from a positive, neutral, and negative value. In some embodiments, the value is a scalar intensity value. In some embodiments, the regression model comprises a linear regression. In some embodiments, the generative model is a generative adversarial network (GAN). In some embodiments, the latent representation is a tensor.

In some embodiments, a method of constructing a customized generative model, comprises reading a plurality of synthetic images and associated latent representations. The method may comprise presenting each of the plurality of synthetic images to a user via a client computing platform. The method may comprise reading a plurality of inputs to the client computing platform. The plurality of inputs may characterize a plurality of values for associated attributes of each of the plurality of synthetic images. The method may comprise determining a plurality of summary latent representations, each corresponding to a unique value of the plurality of associated attributes.

In some embodiments, the method further comprises receiving target values for the plurality of attributes; selecting summary latent representations from the plurality of summary latent representations corresponding to the received target values; providing the selected summary latent representations to a generative model and receiving therefrom an image embodying the target values for the plurality of attributes.

In some embodiments, determining each summary latent representation comprises averaging the latent representations of each synthetic image having the unique value.

In some embodiments, a computer program product for constructing a customized generative model, the computer program product comprising a computer readable storage medium having program instructions embodied therewith, the program instructions executable by a processor to cause the processor to perform a method according to any one of the above embodiments.

In some embodiments, a method of generating a synthetic image comprises reading an input image; encoding the input image into a latent representation in a latent space; reading target values for one or more image attributes; modifying the latent representation to conform with the target values using a regression model, the regression model relating locations in the latent space to values of the one or more image attributes, thereby generating a modified latent representation in the latent space conforming with the target values; providing the modified latent representation to an image generator, and reading a synthetic image that embodies the target values. The synthetic image may have been generated by the image generator. In some embodiments, the regression model was constructed according to the method of the first embodiment.

In some embodiments, a method of generating a synthetic image comprises reading an input image; encoding the input image into a latent representation in a latent space; reading target values for one or more image attributes; modifying the latent representation to conform with the target values by adjusting the latent representation according to one or more summary latent representations corresponding to the target values, thereby generating a modified latent representation in the latent space conforming with the target values; providing the modified latent representation to an image generator, and reading a synthetic image that embodies the target values. The synthetic image may have been generated by the image generator.

In some embodiments, the summary latent representations were constructed according to the above methods.

### BRIEF DESCRIPTION OF THE SEVERAL VIEWS OF THE DRAWINGS

FIG. 1 is a schematic data flow illustrating the construction of a customized generative model, according to techniques described herein.

FIG. 2 is a graph illustrating variance partitioning coefficients attribute judgment ratings across variance clusters are shown, according to techniques described herein.

FIG. 3 is a flowchart illustrating a method of customizing an existing image according to embodiments of the present disclosure.

FIG. 4 illustrates an exemplary method of constructing a customized generative model, according to techniques described herein.

FIG. 5 illustrates an exemplary method of constructing a customized generative model, according to techniques described herein.

FIG. 6 depicts a computing node according to embodiments of the present disclosure.

FIG. 7A depicts exemplary images generated by customized generative models, according to techniques described herein.

FIG. 7B depicts validation results for a validation study of customized generative models, according to techniques described herein.

FIG. 8A depicts exemplary images generated by customized generative models, according to techniques described herein.

FIG. 8B depicts validation results for a validation study of customized generative models, according to techniques described herein.

FIG. 9A depicts exemplary images generated by customized generative models, according to techniques described herein.

FIG. 9B depicts validation results for a validation study of customized generative models, according to techniques described herein.

FIG. 10 depicts exemplary images generated by generative model, according to techniques described herein.

FIG. 11A depicts exemplary images generated by customized generative models, according to techniques described herein.

FIG. 11B depicts validation results for a validation study of customized generative models, according to techniques described herein.

FIG. 12 depicts results of Exemplary Studies 1, 2, and 4, according to techniques described herein.

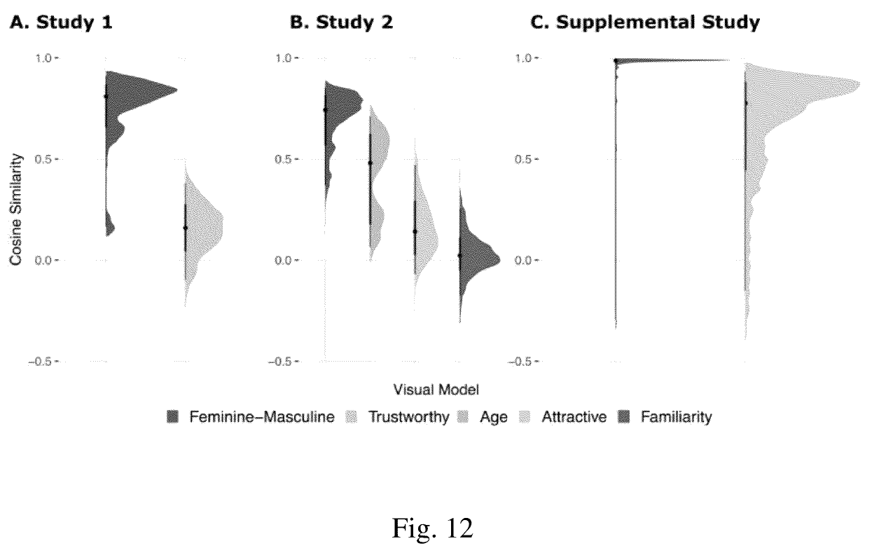

FIG. 13 depicts results of Exemplary Study 3, according to techniques described herein.

FIG. 14 depicts the cosine similarity latents across trials during a validation study, according to techniques described herein.

FIG. 15 depicts comparisons of cosine similarities between the latent vectors, according to techniques described herein.

### DETAILED DESCRIPTION

Embodiments of the present disclose describe processes for automatically, quickly, and realistically generating and modifying photographs of any given visual object or stimulus category (e.g., cars, bicycles, shoes, etc.) along a range of human impression dimensions. A human impression dimension is an attribute (e.g., speed, cost, quality, etc.) along which human observers can rate/judge/categorize images of a given object class. The described approach means, for example, that it is possible to model what makes a car look fast to observers, independent of (and entirely agnostic to) whether that means a car actually is fast in reality.

In some embodiments, the methodological pipeline consists of partially custom software running on commercially available computer hardware (NVIDIA graphics processing units or GPUs), and is dependent on crowdsourced datasets of human ratings of a variety of object categories (e.g., cars, bicycles, shoes). The software solution focuses on both the quality and validity of the photo manipulation, aiming to produce automatic, photorealistic, and statistically valid manipulations of any given visual object. This may be accomplished using a deep neural network capable of generating realistic synthetic object photographs learned from ingesting (tens of) thousands of diverse examples. This network represents each synthetic photograph using a unique set of latent features, and may generate millions of discriminable photographs, as the network maps from features to object photographs. The network is then trained to map any given photo back to these features (from objects to features). A manipulation step happens using the feature representation of the image: using a statistical model, the model is taught to linearly predict human impression ratings given the feature representations with high accuracy and high confidence. This linearity is then exploited to easily increase or decrease the given impression judgment for particular object photos. It is worth noting that a separate dataset must be collected for each object class and each impression dimension. However, this approach can be applied to any such class and dimension.

Methodologies are provided herein for being able to capture these impression dimensions at the shared, global level (i.e., on average, across all surveyed individuals, this type of car looks “fast”) as well individualized models of perception (i.e., this particular type of car looks “fast” to individual A whereas a different car looks “fast” to individual B). The pipeline for the “global” models is described above. For individualized models, instead of training a linear classifier on the global judgment dataset, a categorization task may be employed. Participants classify several hundred randomly generated images from a pretrained model into one of three categories (e.g., this car is “fast”, “slow”, or “unsure/neither”). After the participants classify all stimuli into these categories, the selected latent representations for each category are averaged together, for example, to obtain an individual's average latent representation of a fast, slow, and unsure car. This matrix arithmetic is then used to subtract one category from the other (e.g., “slow” from “fast”) and add it to the averaged “neutral” category (in this case, “unsure/neither”). The result is a manipulated visual object that represents that individual's internalized view of a specific attribute. This procedure is not limited to manipulating just the “neutral” category images. This same procedure may be applied to any image created by the model to make it appear similarly to that individual's internally held representation of the trait of interest. For example, consider that participant A completes a task categorizing cars as “fast”, “slow” or “unsure/neutral.” Not only is an individualized model for participant A created to display a photorealistic representation of a “fast” and “slow” car prototype, but these models can also be applied to newly generated cars for generating thousands of completely novel stimuli that the participant will view as “fast” or “slow”, or mix it with participant B's and participant C's individualized models to generate sub-groups of individualized models (e.g., when participant A, B, and C are all corporation X's target demographic).

The work described above is accomplished post hoc after individuals respond to many target trials. However, embodiments of the present disclosure describe a methodology for being able to develop individualized models in near real time as participants make responses to visual stimuli. That is, as participants make responses to target stimuli, the model will continuously update what it thinks best visually represents that participant's mental model for a specific category. This is accomplished through data reduction (PCA) on the latent space and individualized machine learning on the reduced latent space on a participant-by-participant basis.

These types of human impressions drive consumer behavior and are important for product designers to consider when creating new goods for the market. There is theoretically no limit to the nature and variety of object classes on which this approach can be used. The invention could be useful for artists, photographers, media companies, advertising companies, governments, social scientists, and other individuals and groups who study human reactions to people and objects. Some specific uses include, but are not limited to:
Design tools for creating more desirable products to specific individuals, groups of individuals, or the population “on average”;
Population-specific models of these impressions (e.g., what makes a car look “expensive” to the general population in India may be very different to what looks “expensive” to the US population);
Detecting artificial manipulations along human impression dimensions;
Photograph database searches based on human impression judgments; and
Image compression that prioritizes maintaining impression judgments over other perceptual information.

Further, embodiments of the present disclosure allow for automatic, photorealistic manipulation of object photographs along scientifically validated human impression dimensions, both at a global level and at an individualized level. It will allow users to perform at least four functions that do not exist on the market today: (1) generate both global and individualized models on (potentially) any visual object; (2) generate an arbitrary number of objects (e.g., cars) with highly controlled features that correspond to perceived judgments (e.g., one could generate 1,000 sports cars that appear highly affordable); (2) modification of any object photograph along impression dimensions with arbitrary precision (e.g., making a car appear more fast, or expensive, or safe, or all of the above, and so on); (3) providing automatic confidence estimates for different impressions that the images will form in human observers, allowing direct comparison between images for their psychological qualities (e.g., choosing between several different options for a car design based on the model's estimated ratings of “safety” or “cost”).

One of the most important recent advances to computer vision has been the generation of photorealistic synthetic images. Generative adversarial networks (GAN) accomplish this by pitting two machine learning models in “competition” against each other with the goal of creating better and better output. A generator model produces synthetic output data (often an image) in an attempt to “fool” a separate discriminator model simultaneously trained to discern “real” from “synthetic” data. Generative adversarial networks have been used to create a variety of image classes, ranging from faces to house facades, cars, and animals, among many others. A generative model learns to produce new images by dynamically updating its output based on whether or not the discriminator model can tell whether its output is a real image or a generated image. Similarly, the discriminator model dynamically improves its performance using the feedback it receives from the generator model.

Generative adversarial networks (GANs) are systems of two neural networks contesting with each other in a zero-sum game framework. One network generates candidates and the other evaluates them. The generative network learns to map from a latent space to a particular data distribution of interest, while the discriminative network discriminates between instances from the true data distribution and candidates produced by the generator. The generative network's training objective is to increase the error rate of the discriminative network. In this way, it is trained to produce novel synthesized data that appear to have come from the true data distribution.

A known dataset may serve as the initial training data for the discriminator. Training the discriminator involves presenting it with samples from the dataset until it reaches some level of accuracy. The generator may be seeded with a randomized input that is sampled from a predefined latent space (e.g., a multivariate normal distribution). Thereafter, samples synthesized by the generator are evaluated by the discriminator. Backpropagation may be applied in both networks so that the generator produces better data (e.g., images), while the discriminator becomes more skilled at flagging synthetic images. In various embodiments, the generator is a deconvolutional neural network and the discriminator is a convolutional neural network.

An autoencoder is a neural network that learns to compress data from the input layer into a short code, and then uncompress that code into something that closely matches the original data. This forces the autoencoder to engage in dimensionality reduction, for example by learning how to ignore noise. Autoencoders are also useful as generative models.

One GAN that has received considerable attention and research is StyleGAN, a machine learning model capable of producing different types of images at high resolution that are nearly indistinguishable from real world photos. In some implementations, StyleGAN2, StyleGAN3, and/or other iterations of StyleGAN are suitable alternative for StyleGAN. StyleGAN has been able to generate human faces with incredible fidelity and precision, mimicking real-world face photographs while also being able to construct new face images of non-existent individuals. While StyleGAN is discussed below in reference to the model's ability to generate human faces, it should be noted that GANs as discussed herein are not limited to the generation of human faces and can be used more broadly to produce images of objects.

In addition to creating high resolution output, StyleGAN is useful in manipulating objects along a number of dimensions of psychological interest. For example, one may identify where in the StyleGAN latent space demographic attributes such as age and sex/gender exist. Identifying latent directions for such attributes then allows for any images (e.g., faces) generated to be moved along those directions and thereby manipulated along age (young to old) and/or sex/gender (perceived male to perceived female).

There is nothing limiting the discovery of latent directions within the latent space to such (first-order) demographic features. For example, one recent paper applied modeling techniques previously used for characterizing representations of psychological perceived attributes in 3D computer-generated faces to the StyleGAN2 latent space. By collecting over 1 million judgments of 1,004 synthetic faces from over 4,150 participants, the researchers visualized 34 perceived attribute dimensions. These dimensions included such first-order judged dimensions as perceived “masculinity,” as well as second-order judged dimensions such as perceived “trustworthiness.” These perceived dimensions in particular were able to be modeled with great fidelity, owing to the high inter-rater reliability of participants' judgments.

While embodiments of the present disclosure may rely on a particular type of GAN for the generation and transformation of objects, the field of machine learning continues to rapidly advance and new methods emerge regularly. Recently, research groups from companies such as OpenAI and Google have created especially powerful generative diffusion models (DALL-E 2 and Imagen, respectively) via a technique known as Contrastive-Language-Image-Pretraining (CLIP). Among other things, these models allow for the creation of arbitrary images from text prompts, which can themselves be quite descriptive (e.g., “a racoon detective in New York City wearing a trench coat under a streetlight”). In addition, it is possible to quickly generate many variants of a given image, or to edit the content of an image by applying a mask to an area of the image and asking for a desired change with further text (e.g., “add a bed” to a masked area of a scene, which will then be filled with a bed). The availability of such models to the general public is currently limited for various reasons (including concerns of potential abuse by unethical actors) but may prove enormously useful to the broader psychological research community, both for stimulus generation and analysis/exploration of participant data.

Although the methods, systems, and computer program products are described herein primarily with regard to the use of generative adversarial networks, this is not intended to be limiting. In some implementations, other generative machine learning models may be used in place of generative adversarial networks. For example, other machine learning models suitable for such implementations include generative models that operate on an underlying latent space. One exemplary class of such generative models is diffusion models. Further, the generative machine learning models may be configured to process text, audio, images, and/or other media. For example, a suitable generative machine learning model is bidirectional encoder representations from transformer (BERT).

The generative model in the GAN architecture learns to map points in the latent space to generated images. The latent space defined by the generative model has no meaning other than that applied to it via the generative model. When interpreted by the generator model, the latent space has structure that can be explored, such as by interpolating between points and performing vector arithmetic between points in latent space which have meaningful and targeted effects on the generated images. For each given model, the structure can be queried and navigated by the user or by an automated search process.

The generator model in the GAN architecture takes a point from the latent space as input and generates a new image.

As described above, the latent space itself has no meaning. In exemplary embodiments, the latent space comprises a 100-dimensional hypersphere (e.g., represented as a tensor) with each variable drawn from a Gaussian distribution with a mean of zero and a standard deviation of one. Through training, the generator learns to map points into the latent space with specific output images. This mapping will be different each time the model is trained. Typically, new images are generated using random points in the latent space. Taken a step further, points in the latent space can be constructed (e.g., all 0's, all 0.5's, or all 1's) and used as input or a query to generate a specific image.

A series of points can be created on a linear path between two points in the latent space, such as two generated images. These points can be used to generate a series of images that show a transition between the two generated images. Finally, the points in the latent space can be kept and used in simple vector/tensor arithmetic to create new points in the latent space that, in turn, can be used to generate images. This allows for the intuitive and targeted generation of images.

Within exemplary deep convolutional generative adversarial networks, a stable model configuration is provided for training deep convolutional neural network models as part of the GAN architecture. The latent space for such GANs can be fit on a number of different training datasets, such as a dataset of faces. In this way, vector arithmetic with faces can be achieved. For example, a face of a smiling woman minus the face of a neutral woman plus the face of a neutral man results in the face of a smiling man. As set out herein, personalized transformations may be applied in the latent space to arrive at images that have perceptual attributes specific to an individual or group.

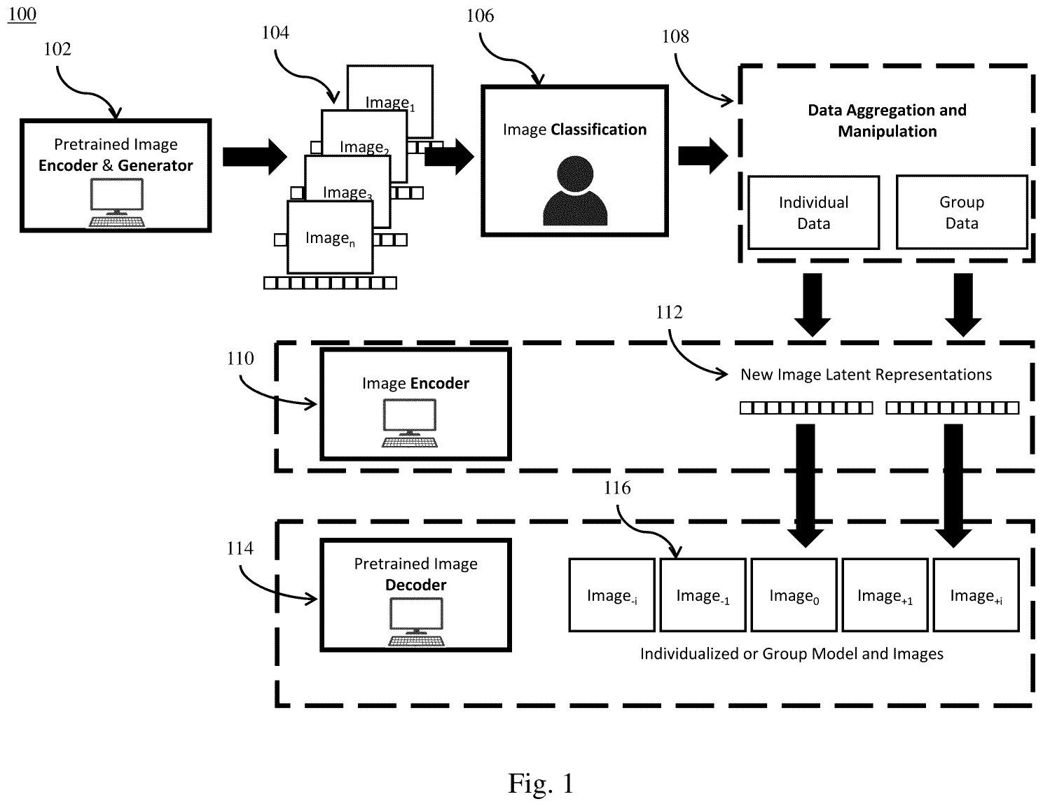

With reference now to FIG. 1, an exemplary process flow 100 is illustrated. A pretrained image encoder and generator in 102 is used to generate N images and associated latent representations in a latent space. Pretrained image encoder and generator 102 can be any generative model that produces images and operates within the image's latent space (e.g., StyleGAN, Stable Diffusion, etc.).

After generating synthetic images and associated latent spaces (“latents”) at the pretrained image encoder and generator 102, the generated images and latents 104 may be stored in a storage step for future retrieval and processing. Generated images 104 are provided for image classification step 106. For image classification, human participants judge the generated synthetic images (not the associated latents) on characteristics or impressions of interest, for example using a three-choice classification procedure. For example, the participant may be asked “is this person trustworthy?” when presented with a synthetic image of a face, or “is this car fast” when presented with a synthetic image of a car. Possible responses may include “trustworthy,” “neither/unsure,” and “untrustworthy,” or in the case of the car image, “fast,” “slow,” and “neither/unsure.” The synthetic image presented to the participant may comprise any object, not just a face or car.

After image classification occurs, step 108 comprises data aggregation and manipulation across both individual datasets and group datasets in order to arrive at user- or group-specific profiles. In exemplary embodiments, a participant's response data is aggregated by averaging the latents (not synthetic images) associated with each synthetic respresentation across the three classification categories within that participant's data. In exemplary embodiments, group data are aggregated by averaging the latents associated with each synthetic representation across the three classification categories across all participants sampled.

Once data is aggregated across both individual and group datasets, new image latent representations 112 are generated, either by directly manipulating latents 104 or using image encoder 110. In some embodiments, image encoder 110 is the encoding component of encoder/generator 102. In various embodiments, an initial latent image representation is generated from an input image. An initial representation may also be read from a datastore. The latent representation is manipulated, e.g., by subtracting one classification category's average latents from the other (for example, subtracting the “slow” latent values from the “fast” latents), and adding them to the third classification category (i.e., the “neither/unsure” average latents). This process may be applied across both individual and group level datasets. In step 116, individualized or group-specific images are generated by a pretrained image decoder 114 based on the individualized or group models determined in aggregation step 108. In some embodiments, pretrained image decoder 114 is the image generation component of encoder/generator 102. In such embodiments, new synthetic images 116 are created by feeding the manipulated latents back into the pretrained image generator 102. Different values and/or intensities of images can be created by multiplying the individual or group latent representation vector by a constant (e.g., +/−3) to increase or diminish a given perceptual attribute. In some implementations, the individual or group latent representations are normalized prior to being multiplied by the constant.

One aspect of the described process is to show that the procedure can visually capture individual perceptual judgments in a predictable manner. Such perceptual judgements may be first-order social judgment (“feminine/masculine”) and second-order social judgment (“trustworthy”), as well as judgements without such a strong social component (“fast/slow”). Certain attributes vary with respect to the shared and idiosyncratic contributions to judgments. More specifically, while all individual mental representations are idiosyncratic to some degree, first-order social judgments (i.e., feminine/masculine) tend to vary less across individuals compared with second-order social judgments (i.e., trustworthy).

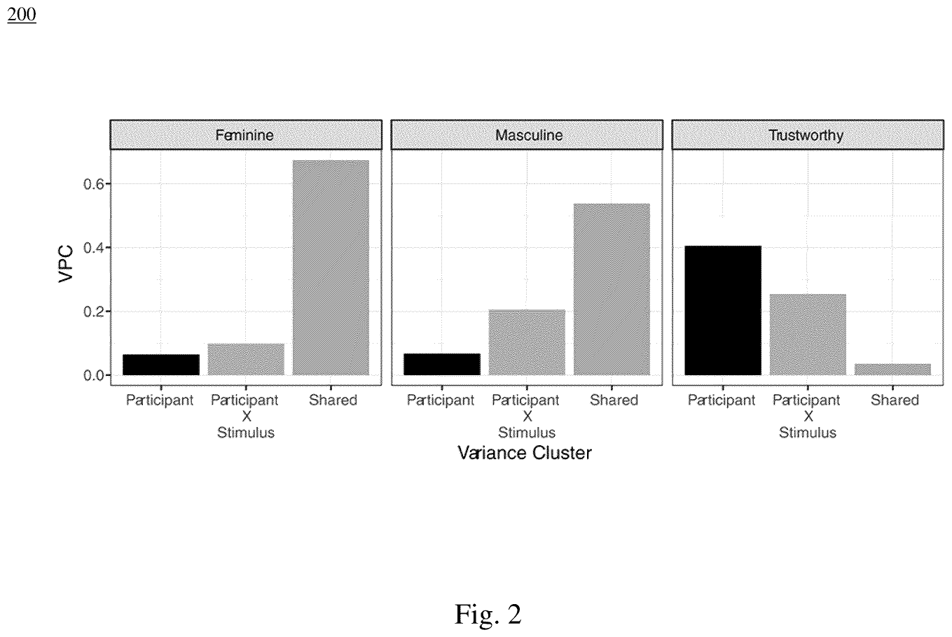

In FIG. 2, exemplary variance partitioning coefficients (VPC) for feminine, masculine, and trustworthy judgment ratings across important variance clusters are shown. The x-axis of graph 200 represents idiosyncratic (participant and participant by stimulus, where the stimulus is an image of a face) and shared variance clusters. The y-axis represents the proportion of observed variance explained by each cluster. Despite increasing evidence that there are large idiosyncratic contributions to judgments across a variety of domains, the degree to which there is more idiosyncratic variance over shared variance is likely graded within these specific domains. For example, within the domain of facial judgments, low level, first-order judgments that underlie higher level, second-order judgments are likely to have higher agreement. First-order judgments such as those for masculinity, femininity, skin tone, hair color, face shape, among others are likely to have more shared agreement since these attributes tend to be less perceptually ambiguous. In contrast, there is likely to be less agreement (i.e., more idiosyncratic contributions) for second-order judgments, such as those for attractiveness, trustworthiness, and dominance due to highly individualized preferences for these perceived attributes.

These findings may be extended to judgments based on other individualized preferences for attributes like speed when presented with an image of a car and/or other individualized preferences. When the relative proportion of each type of variance was examined, different patterns were observed dependent on whether the judgment was first-order (feminine or masculine) or second-order (trustworthy) as depicted in FIG. 2. Specifically, it was found that shared variance in judgments of facial masculinity and femininity accounted for approximately 60% of the observed reliable variance (depicted via the large blue bars in the left and center panels) but <4% of the reliable shared variance in judgments of trustworthiness (depicted via the small blue bar in the right panel). Importantly, this pattern flips when idiosyncratic contributions are examined. Idiosyncratic variance accounted for <20% of the variance for feminine and masculine face judgments (depicted via the black and yellow bars in the left and center panels) and around 20-65% of the idiosyncratic variance for trustworthy judgments (depicted via the black and yellow bars in the right panel) depending on whether participant main effect variance components are taken into account. For example, if the participant is presented with an image of a car, first order judgments may involve speed, while second order judgments involve dependability. In this case, idiosyncratic contributions may also have an effect on the shared variance.

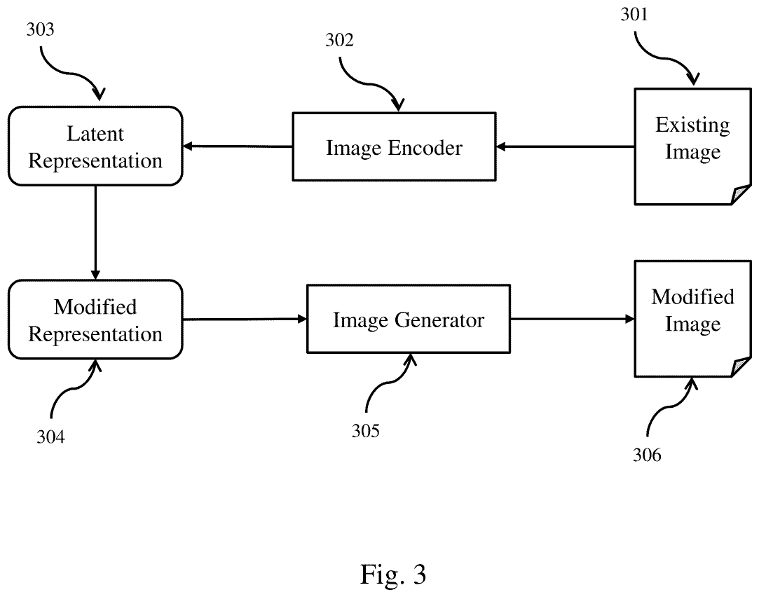

Referring now to FIG. 3, an exemplary method of customizing an image is illustrated. An existing image 301 is read. In various embodiments, the existing image may be a digital image captured from a camera. In various embodiments, the existing image may be a synthetic image generated by a variety of image generation methods including a generative model. Existing image 301 is provided to image encoder 302 to produce latent representation 303. Image encoder 302 may be a trained neural network such as a convolutional neural network (CNN) configured to project an input image into a predetermined latent space. Latent representation 303 is modified to yield modified representation 304. In various embodiments, modifying the latent representation includes applying a trained model (such as the linear models described herein) to adjust one or more attribute of the latent representation. In various embodiments, modifying the latent representation includes performing matrix/tensor arithmetic based on one or more previously determined matrix/tensor representing a given value of a given attribute as described elsewhere herein. In this way, a perceptual characteristic of the input image may be modified within the latent space. Modified latent representation 304 is provided to image generator 305, which generates an image corresponding to the input representation. In various embodiments, image generator 305 is the generator component of a generative adversarial network (GAN). Image generator 305 may be any image generator operative to project from the latent space of the latent representation to an image.

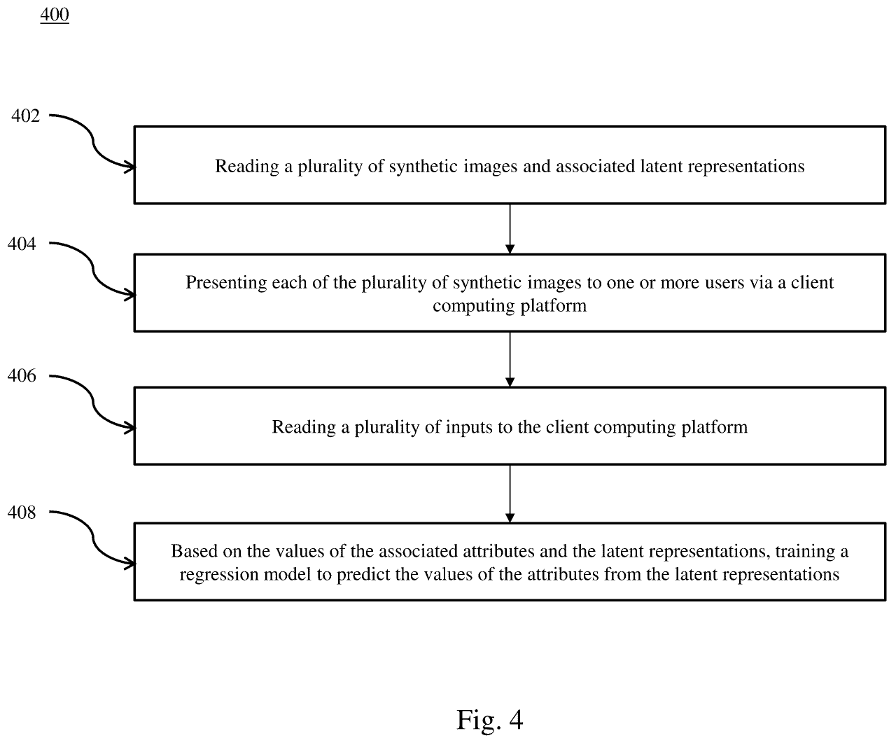

FIG. 4 illustrates an exemplary method 400 of constructing a customized generative model. In step 402, the method may include reading a plurality of synthetic images and associated latent representations. The plurality of synthetic images includes images generated by a generative model, in some cases based on each image's associated latent representation. The generative model may be pretrained on a single object type, such as a car. Generation of the plurality of synthetic images may comprise random selections from a latent space of the generative model. In some embodiments, the associated latent representation of each synthetic image may be generated by providing the synthetic image to the encoder, such as an artificial neural network.

In step 404, the method may include presenting each of the plurality of synthetic images to one or more user via a client computing platform. The images may be customized to a group comprising the one or more users. In some embodiments, there may be only one user, in which case the images are customized to the one user. The received value may be a scalar intensity value.

In step 406, the method may include reading a plurality of inputs to the client computing platform. The plurality of inputs may characterize a plurality of values for a plurality of associated attributes of each of the plurality of synthetic images.

In step 408, the method may include, based on the values of the associated attributes and the latent representations, training a regression model to predict the values of the attributes from the latent representations. In some embodiments, the regression model is a linear regression. This regression model represents a customized generative model based on the input images and user feedback. In some embodiments, the method may further include receiving target values for the plurality of attributes, using the regression model to determine a target latent representation corresponding to the target attributes, and providing the target latent representation to a generative model and receiving therefrom an image embodying the target values for the plurality of attributes.

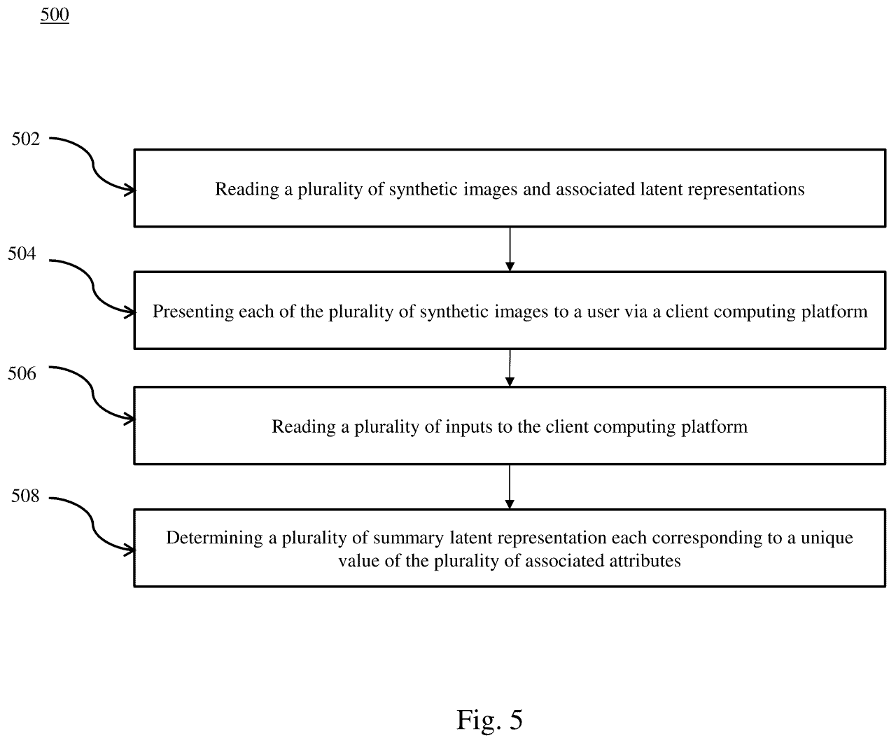

FIG. 5 illustrates an exemplary method 500 of constructing a customized generative model. In step 502, the method may include reading a plurality of synthetic images and associated latent representations.

In step 504, the method may include presenting each of the plurality of synthetic images to user via a client computing platform. In step 506, the method may include reading a plurality of inputs to the client computing platform. The plurality of inputs may characterize a plurality of values for a plurality of associated attributes of each of the plurality of synthetic images.

In step 508, the method may include determining a plurality of summary latent representations each corresponding to a unique value of the plurality of associated attributes. This determination may include averaging the latent representations of each synthetic image having the unique value.

In some embodiments, the method may include receiving target values for the plurality of attributes, selecting summary latent representations from the plurality of summary latent representations corresponding to the received target values, and providing the selected summary latent representations to a generative model and receiving therefrom an image embodying the target values for the plurality of attributes.

The following exemplary methodology for the hyper-realistic visualization procedure loosely follows that of a typical psychophysical reverse correlation procedure. However, there are several major differences whereby state-of-the-art technical innovations are leveraged. Specifically, in an embodiment, the methodological procedure consists of four steps: (1) image inversion; (2) stimulus creation; (3) stimulus selection (by participants); and (4) stimulus analysis (i.e., classification image creation). Below, each of these methodological steps are briefly introduced and the results from a proof-of-concept investigation are detailed.

### Step 1: Image Inversion

The first step consists of inverting a set of images into the StyleGAN2 latent space. In short, GAN inversion is a process whereby a real object image is reconstructed (located) within a pre-trained GAN latent space. A successful inversion results in an image that is photorealistic, similar in appearance to the original image, and editable (i.e., maintains the same characteristics of the GAN latent space into which it was inverted so that attributes present in the latent space can be applied to the inverted image). Inverting an image results in a 18×512 matrix of numeric values that represents that object in the StyleGAN2 latent space.

In an exemplary dataset, a set of 2,484 neutral objects (e.g., faces) were inverted from various available databases into the StyleGAN2 latent space using a modified VGG encoder. The neutral objects were taken from several face databases: the Chicago Face Database, FACES, NIMSTIM, RAFD, Face Database, Face Research Set London, FERET, and RADIATE image sets, as well as a number of internal object resources. Because of the oversaturation of the original StyleGAN2 latent space with smiling faces due to the original training data, the focus was to invert real neutral face images. An overrepresentation of smiling faces (or any other type of face/attribute) is undesirable for obtaining an accurate classification image (i.e., individual face prototype or representation). In validation tests, an oversampling of smiling faces in the image pool shown to participants resulted in classification images that also overrepresented “smiley” attributes.

### Step 2: Stimulus Creation

In a general reverse correlation study, stimuli are created by overlaying random sinusoidal noise over a standardized, singular base image. Much like the original reverse correlation procedure, stimuli were created by randomly generating random neutral faces from the GAN latent space and adding a small amount of Gaussian noise. To generate random, unique neutral faces from the latent space, the latents of a subset of 10 randomly selected faces from the 2,484 faces were averaged together and inverted into the model latent space from the previous step. Next, a small amount of random Gaussian noise was averaged to the averaged latent to further differentiate it from the pool of inverted faces. This two-step process was repeated for each stimulus generated.

From this, 300 neutral face stimuli were generated using the above process. Noise was sampled from a Gaussian distribution with parameters μ=0 and σ=0.4 to be added to each generated average image.

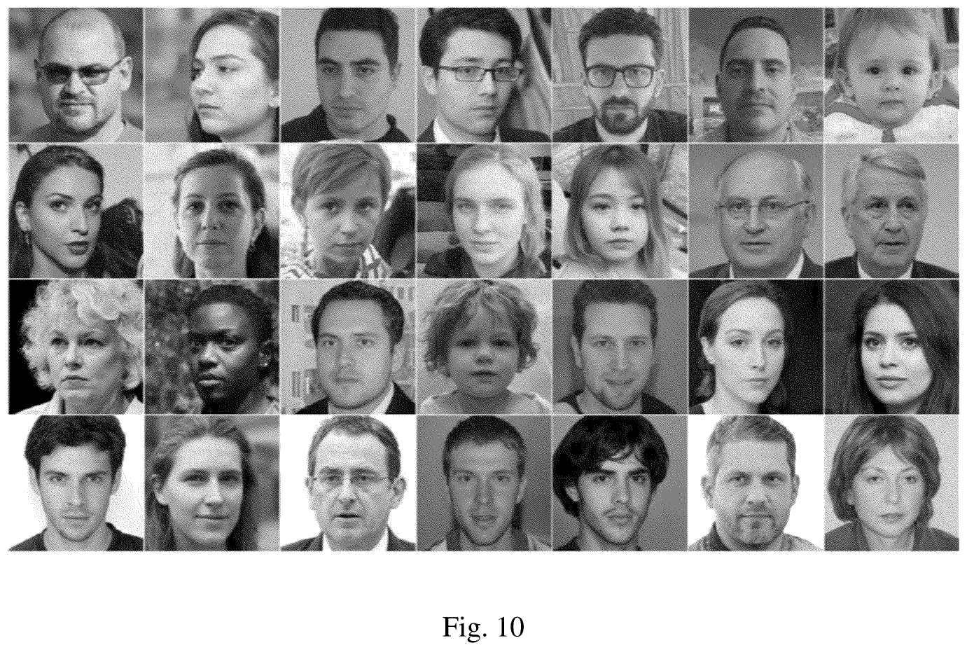

In alternative implementations, stimuli are created by sampling directly from the latent space. The stimuli may be sampled without first projecting specific stimuli into the latent space. Creating the stimuli may comprise training a machine learning model configured to output high quality stimuli images that are neutral in appearance. By way of non-limiting example, the machine learning model may be configured to generate high quality face images having neutral appearances. By way of non-limiting example, the machine learning model may be based on a StyleGAN2 model. The stimuli may be sampled from the latent space of the machine learning model. The machine learning model may be trained using a training dataset comprising neutral-appearing stimuli. For example, the training dataset may comprise only neutral-appearing stimuli. By way of non-limiting example, neutral-appearing face stimuli may be obtained from one or more of the FFHQ dataset, the CelebA-HQ dataset, online image scraping, and/or other sources. The trained machine learning model may be referred to as the Neutral and Minimally Expressive Faces-High Quality (NAMFHQ) model. FIG. 10 depicts exemplary images generated by the NAMFHQ model.

### Step 3: Stimulus Selection

The stimulus selection procedure involves displaying each image sequentially to participants and asking them to categorize the face based on a specific set of attributes designated by the researcher. In contrast to alternative reverse correlation procedures, which use a two-alternative forced-choice design (i.e., selecting between two images), a design with three potential categorizations for a single image may be utilized-that is, a single image may be displayed to the participant along with three response options. In this task, each of the categories may be as follows: (1) the attribute of interest (e.g., perceived “trustworthy”), (2) the conceptual opposite of this attribute (e.g., perceived “untrustworthy”), and (3) “neutral” (or “neither”). For example, if a researcher is interested in visualizing an individual's mental representation of perceived “masculinity,” participants would be asked to select whether they think each face appears “masculine,” “feminine,” or “neither.” The rationale for including a “neutral” or “neither” category is to obtain an unbiased, individual starting point within the latent space for each participant. That is, much like the target categories, what one individual categorizes as “neither” is likely to differ from one participant to the next. The participant selections are binned into each of the three categories and used for analysis in the next step.

Two sets of judgments were used in the validation experiment, “trustworthy/untrustworthy/neither” and “masculine/feminine/neither.” Participants were assigned to one of the conditions and tasked with categorizing each face stimulus into one of the three categories. Every participant saw the same 300 faces generated in the previous step, though presentation order was randomized between participants.

### Step 4: Stimulus Analysis

Stimulus analysis involves matrix arithmetic on the latents of the selected images for each participant. First, the image latents for each selected category may be averaged together. Second, the latent matrix of the non-target category is subtracted from the latent matrix of the target category. This process isolates the unique features attributable to the perceived target attribute in the latent space. For example, subtracting the average “untrustworthy” latent matrix from the average “trustworthy” latent matrix yields a new latent matrix that represents the qualities unique to perceived trustworthiness for a given participant. The result of this operation represents a directional vector in the latent space that can be used to sample the mental representation of the desired perceived attribute at varying levels of intensity. This may be accomplished by adding the directional vector to the averaged latent matrix of the “neither” selections, which represents a starting point in the StyleGAN2 latent space for estimating an individual's mental model for a particular trait. Consequently, multiplying the directional vector matrix by a constant before adding it to the averaged “neither” latent matrix produces visualizable mental representations for the trait at different levels of intensity.

More formally, A∈ [symbol] ^{m×n} is an 18×512 dimensional matrix that represents the averaged latents for the faces selected to represent a target trait. Similarly, B∈ [symbol] ^{m×n} is a 18×512 matrix of the averaged latents for the non-target or non-selected faces. The directional vector matrix, Âₗ, for a particular subject, i, can be computed as,

$$\hat{{A}_{ι}} = \overline{{A}_{ι}} - \overline{{B}_{ι}}$$

In some implementations, the directional matrix is normalized to standardize vector lengths. The directional matrix may be normalized such that

$$\hat{{A}_{ι}} = \frac{\overline{{A}_{ι}} - \overline{{B}_{ι}}}{‖ \overline{{A}_{ι}} - \overline{{B}_{ι}} ‖}$$

This directional matrix can be applied to the averaged neither latent matrix, N∈ [symbol] ^{m×n}, to compute a starting point of an individual's mental representation of the target trait,

$${M}_{i} = \overline{{N}_{ι}} + \hat{{A}_{ι}}$$

Finally, when the directional vector matrix is multiplied by a constant, C, the mental representation image, M_{ic}, can be estimated at varying intensities,

$${M}_{i c} = \overline{{N}_{ι}} + \hat{{A}_{ι}} C$$

The extrapolated mental representations exemplify the individual's internal prototypes for the particular trait measured at various levels of intensity.

Individual classification images were computed for each of participant following the procedure outlined above. If participants did not categorize any faces as “neither,” a random sample of 20 faces were drawn from the pool of 300 faces and averaged together as a proxy starting point in the latent space. Experiments utilizing different random subsets of images did not meaningfully change the visual results of the output images.

### Exemplary Study 1

Two judgments-femininity/masculinity and trustworthiness-were used as these two are clearly different with respect to the relative proportion of shared and idiosyncratic variance. Whereas most of the meaningful variance in femininity/masculinity is shared variance, most of the meaningful variance in trustworthiness judgments is idiosyncratic. Seventy-six participants (M_{age}=39.61, SD_{age}=10.30) were recruited through CloudResearch for the experiment. Participants in Phase I self-identified as follows: 26 women, 47 men, 1 non-binary, 2 not reported; 6 Asian, 12 Black, 2 Latinx, 49 White, 3 more than one race, and 4 other/not reported. One-hundred and ten participants (M_{age}=39.63, SD_{age}=10.26) were also recruited through CloudResearch to judge the stimuli generated by the visual models of participants from the first stage. Participants in Phase II self-identified as follows: 43 women, 62 men, 3 non-binary, 2 other/prefer not to answer; 4 Asian, 19 Black, 3 Latinx, 76 White, 6 more than one race, and 2 other/not reported.

In the first stage of the experiment (Phase I), participants categorized randomly generated synthetic-but realistic-appearing-faces on the respective judgment dimensions. The participant's categorizations were used to create idiosyncratic visual models of their judgments.

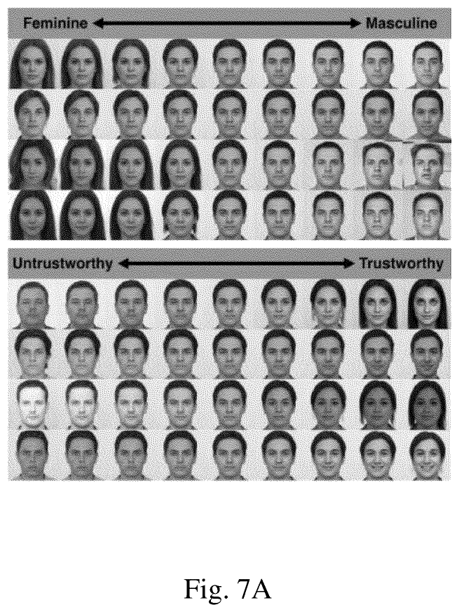

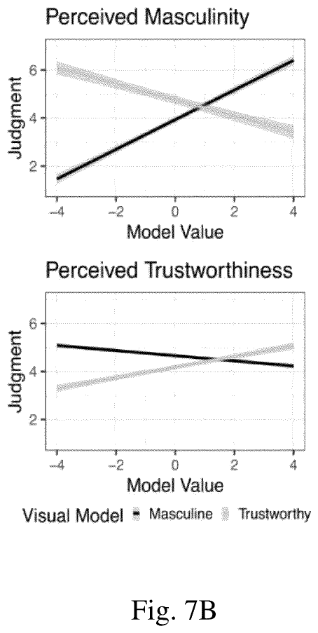

FIG. 7A depicts exemplary images generated from Phase I participants' idiosyncratic visual models for each condition. The center image in each row represents the average of all of the latents each participant selected as the “neutral” category. Images to the left and right of the center image represent the linear interpolation at +/−2, 4, 6, and 8, respectively.

300 neutral face stimuli were generated by projecting real neutral faces into the latent space, averaging 10 faces together, and adding noise to further differentiate each face from the real faces (see Supporting Information for more details). Noise was sampled from a Gaussian distribution with parameters μ=0 and [symbol] 0.4 to be added to each averaged image. Individualized images for each of the participants using linear interpolation (i.e., model values) with values ranging from −8 to +8 were computed. If participants did not categorize any stimuli as “neutral/neither”, a random sample of 25 stimuli were averaged together to act as a starting point in the latent space and added to their idiosyncratic visual models.

The removal of 11 poor quality participants from Phase I resulted in a total of 260 images generated by the idiosyncratic visual models to be judged by participants in Phase II (65 participants×4 images each at model values −4, −2, +2, and +4).

Consistent with variance partitioning studies, the participant's individual models of femininity/masculinity judgments were expected to be more similar to each other than the participant's individual models of trustworthiness judgments.

The objective was to validate models generated during Phase I. Participants' ratings were expected to track with the models' predicted values (e.g., faces manipulated to appear trustworthy would be rated as more trustworthy). Further, given that judgments of trustworthiness and masculinity are negatively correlated, the judgments were expected to be differentially sensitive to the two judgment models (e.g., the slope of trustworthiness judgments would be positive for faces generated from trustworthiness models and negative for faces generated from masculinity models).

Cosine similarity was used to assess the similarity between latent vectors for each of the participants' visual models constructed in Phase I. Because each model is a vector of real numbers in the generative model's latent space, the average cosine similarity was calculated for each participants' individualized model vector and every other participant's model vector. Consistent with previous variance partitioning studies that show more consensus for judgments of femininity and masculinity compared to judgements of trustworthiness, the average similarity of feminine-masculine idiosyncratic visual models was significantly higher than that of trustworthy-untrustworthy idiosyncratic visual models, t(46.98)=21.98, p<001, d=5.09.

Cosine similarity was correlated with participants' test-retest reliability for feminine-masculine visual models, r(33)=0.76, p<0.001, but not for trustworthy-untrustworthy visual models, r(28)=−0.25, p=18, suggesting that whereas for highly shared visual models, differences from the average can be partially explained by noise (i.e., noisy, less reliable participants), for idiosyncratic models these differences reflect genuine idiosyncratic differences.

In the second stage of the experiment (Phase II), a new sample of participants rated faces generated by the models of individual participants from the first stage. 10% of the trials in Phase I were randomly selected and all of the trials in Phase II to be repeated in order to assess test-retest reliability for each participant. Participants were excluded if they had negative or near zero (r<0.05) test-retest correlation. Based on this criterion, 11 participants' visual models from Phase I and 16 participants from Phase II were removed from analyses. The linearly interpolated images at values of −4,−2, +2, +4 were selected from each Phase I participant's model to act as stimuli for Phase II (N=304; 76 Phase I participants×4 images each¹). Only model images at values up to +/−4 were used to prevent participants in Phase II from judging images with potential artifacts (i.e., the visual model going out of sample when interpolating).

The pattern of findings was similar for judgments of trustworthiness. Faces manipulated to appear more trustworthy were rated as more trustworthy, whereas faces manipulated to appear more masculine were rated as less trustworthy. The interaction between model type (feminine-masculine vs. trustworthiness) and model value (−4 to +4) was significant, b=0.32, t(260)=19.94, p<0.001 (the main effect of model was also significant b=−0.46, t(260.56)=9.08, p<0.001). Simple slopes analyses for each visual model showed a positive and significant effect for trustworthy visual models, b=0.21, t(253)=17.98, p<0.001, and a negative and significant effect for feminine-masculine visual models, b=−0.11, t(269)=9.98, p<0.001.

Taken together, these results show that images produced from the idiosyncratic models in Phase I were judged as intended across each model value. In other words, images generated through participants' visual models of feminine-masculine or trustworthy-untrustworthy both qualitatively (i.e., through visual inspection) and empirically represented the intended category, replicating previous research.

Phase II participants judged the faces produced from each Phase I visual model as intended. FIG. 7B depicts the Phase II validation results whereby a second group of participants judged the +/−4 and +/−2 idiosyncratic visual model images generated in Phase I on how “masculine” or “trustworthy” each appeared. The x-axis represents the model interpolation values and the y-axis represents participants' responses. Shaded areas around each line display 95% confidence intervals. Faces manipulated to appear more masculine were rated as more masculine. Faces manipulated to appear more trustworthy were rated as less masculine. The latter finding reflects the fact that masculine faces are perceived as less trustworthy. These findings were reflected in a significant interaction between visual model type (feminine-masculine vs. trustworthiness) and model value (−4 to +4), b=0.96, t(256.14)=27.14, p<0.001 (the main effect of visual model was also significant, b=0.83, t(181.69)=7.39, p<0.001). Simple slopes analyses for each visual model showed a positive and significant effect for feminine-masculine visual models, b=0.63, t(258)=25.95, p<0.001, and a negative and significant effect for trustworthy visual models, b=−0.34, t(254)=12.94, p<0.001.

Supplementary Table 1 is a linear-mixed effects regression table for Exemplary Study 1 “masculinity” ratings. The “Visual Model” variable compared images generated from the “feminine-masculine” visual model to images generated from the “trustworthiness” visual model. The “Model Value” variable (i.e., the image linear interpolation value) ranged from −4 to +4 in increments of two and was treated as a continuous predictor. The model included random intercepts for each participant and face image.

Supplementary Table 2 is a linear-mixed effects regression table for Exemplary Study 1 “trustworthiness” ratings. The “Visual Model” predictor variable compares images generated from other participants' visual models to images generated from participants' own visual model. The “Model Value” variable (i.e., the image linear interpolation value) ranged from −2 to +2 in increments of one and was treated as a continuous predictor. The model included random intercepts for each participant and face image.

Across all studies, validation data were analyzed using linear mixed-effects regressions with fixed effects for type of visual model (e.g., the intended target judgment) and model value (i.e., linear interpolation value), along with random intercepts for participant and image (full linear mixed-effects regression tables are provided in the Supporting Information). All validation studies included repeat trials used to assess participants' test-retest reliability. Participant scores were averaged over repeat observations for each validation regression. All studies using CloudResearch participants (Studies 1, 3, and the 4) were prescreened to be located within the United States and were “CloudResearch approved.”

### Exemplary Study 2

While the systems and methods described herein showed promise in Exemplary Study 1 in terms of both the construction of idiosyncratic visual models and their validation by other observers, a stronger validation would be to show that images produced from a participant's own visual model are judged by that same participant as more representative of their judgments than images from other participants' visual models. Thus, in Exemplary Study 2, the same participants who created the visual models returned and judged both their own and a random sample of images generated from other participants' visual models

As in Exemplary Study 1, cosine similarity was used to assess the similarity between latent vectors for each of the participants' visual models constructed in Phase I. Unlike Exemplary Study 1, cosine similarity was correlated with participants' test-retest reliability for both highly shared visual models, r(113)=0.75, p<001 and highly idiosyncratic visual models, r(95)=0.54, p<0.001. While the correlation was significant for both types of judgments, the correlation for highly shared visual models was significantly larger than that of highly idiosyncratic visual models, z=2.76, p=0.006. Thus, this result theoretically replicates Exemplary Study 1 and suggests that for highly shared visual models, differences from the average visualization can be partially explained by noise.

The four judgments used in Exemplary Study 2 were grouped into two groups for analysis: judgments that are highly shared (feminine-masculine and age) and judgments that are highly idiosyncratic (attractiveness and familiarity). Exemplary Study 2 was conducted both in person and online through the University of Chicago SONA participant pool. Due to the asynchronous and time-consuming nature of this study, some participants started but did not finish the study (N_{incomplete}=16) or took the survey multiple times (Nᵣₑₛₜₐᵣₜ=36), causing multiple responses across different conditions for the same participants. Because of this, only the analyses participants who completed the study in its entirety and did not restart were included. This resulted in a final sample of 211 participants across each of the four conditions: young/old=49; feminine/masculine=64; un/attractive=56; un/familiar=42). One hundred and sixteen out of the 211 participants completed both parts of the study.

Test-retest reliabilities were computed for each participant. Within each subgroup, 10% of images were randomly selected to be shown twice to participants in order to calculate test-retest reliabilities. For Phase II (image ratings), participants judged all images twice across both blocks. Six participants had negative or near zero test-retest reliabilities (r<05). The final sample of participants completed both Phase I and Phase II and used for the validation analyses were: young/old=34; feminine/masculine=33, un/attractive=24, and un/familiar=19.

Stimuli for the image generation phase were created following the same procedure as Exemplary Study 1 with two exceptions. First, the image projection method (i.e., encoder) used to project the neutral faces into the StyleGAN-2 latent space was changed. In Exemplary Study 2, a minimally modified version of the FeatureStyle encoder was used. The image encoder was changed to create stimuli with greater detail after the inversion and averaging process.

Second, 1,000 images (instead of 300) were created by averaging 10 randomly sampled real (but projected) neutral faces. The same amount of random Gaussian noise applied to each averaged latent to further differentiate the face in Exemplary Study 1 was applied in Exemplary Study 2.

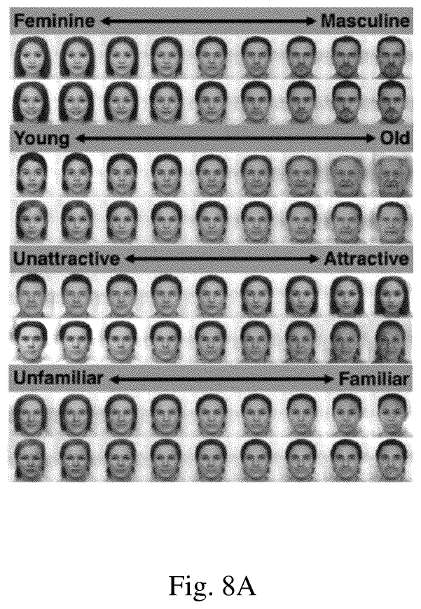

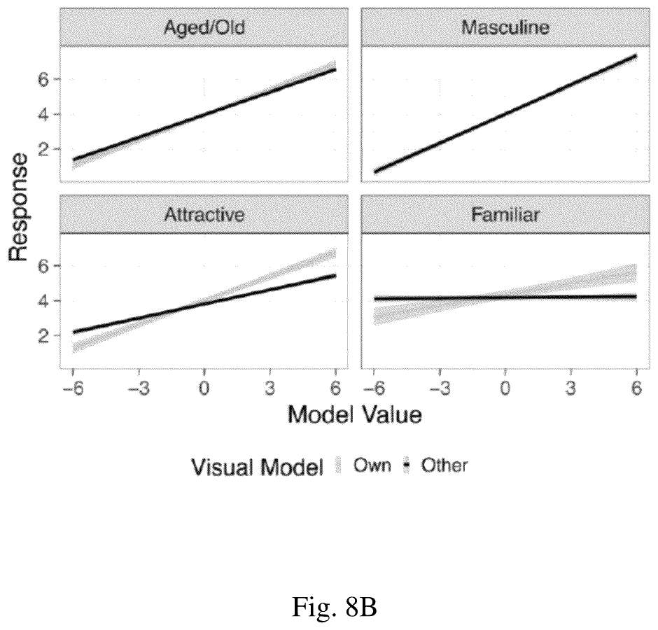

Images for the judgment validation phase were similarly generated following the procedure outlined in Exemplary Study 1. FIG. 8A depicts exemplary images generated from idiosyncratic visual models of two participants across each judgment condition. The center image in each row represents the average of all of the latents each participant selected as the “neutral” category. Images to the left and right of the center image represent the linear interpolation at +/−2, 4, 6, and 8, respectively.

Each participant judged their own visual model's images plus that of five randomly selected other participants' images within the same condition. The findings from Exemplary Study 1 were replicated. FIG. 8B depicts validation results. Each participant judged images generated by their own visual model (yellow lines) and those generated from a random subsample of other participants' visual models (black lines). The x-axis represents the linear interpolation model values and the y-axis represents participants' raw judgment responses. Shaded areas around each line display 95% confidence intervals.

The average similarity of visual models of highly shared judgments was significantly higher than the similarity of visual models of highly idiosyncratic judgments, t(176.51)=26.42, p<0.001, d=3.34. Participants rated the images manipulated by the model to appear more “attractive” as more attractive, b=0.45, t(49.31)=15.91, p<0.001. There was no main effect of visual model type (own vs. other), b=−0.19, t(49.83)=1.71, p=0.093. However, there was a significant interaction, b=−0.18, t(49.37)=5.76, p<0.001. Participants' judgments were more sensitive to their own visual models (b=0.45) than to other participants' visual models (b=0.27). For example, they judged faces at high values of their model as more attractive than faces at high values of other participants' models, and vice versa for faces at low values of the models.

Similarly, images manipulated by the model to appear more “familiar” were rated as more familiar, b=0.21, t(50)=5.57, p<001. There was no main effect of visual model type (own vs. other), b=−0.18, t(50)=1.20, p=0.236, but there was a significant interaction, b=−0.20, t(50)=4.86, p<0.001. Participants judged images manipulated by their own models to appear more familiar (b=0.21) as more familiar, but not faces manipulated by other participants' models (b=0.01).

Supplementary Table 3 is a linear-mixed effects regression table for Exemplary Study 2 “agedness” ratings. The “Visual Model” predictor variable compares images generated from other participants' visual models to images generated from participants' own visual model. The “Model Value” variable (i.e., the image linear interpolation value) ranged from −6 to +6 in increments of two and was treated as a continuous predictor. The model included random intercepts for each participant and face image.

Supplementary Table 4 is a linear-mixed effects regression table for Exemplary Study 2 “masculinity” ratings. The “Visual Model” predictor variable compares images generated from other participants' visual models to images generated from participants' own visual model. The “Model Value” variable (i.e., the image linear interpolation value) ranged from −6 to +6 in increments of two and was treated as a continuous predictor. The model included random intercepts for each participant and face image.

Supplementary Table 5 is a linear-mixed effects regression table for Exemplary Study 2 “attractiveness” ratings. The “Visual Model” predictor variable compares images generated from other participants' visual models to images generated from participants' own visual model. The “Model Value” variable (i.e., the image linear interpolation value) ranged from −6 to +6 in increments of two and was treated as a continuous predictor. The model included random intercepts for each participant and face image.

Supplementary Table 6 is a linear-mixed effects regression table for Exemplary Study 2 “familiarity” ratings. The “Visual Model” predictor variable compares images generated from other participants' visual models to images generated from participants' own visual model. The “Model Value” variable (i. e., the image linear interpolation value) ranged from −6 to +6 in increments of two and was treated as a continuous predictor. The model included random intercepts for each participant and face image.

Specifically, participants judged images generated from their own visual models as more representative of the target judgment compared to images generated from others' visual models. However, this only appears to be the case when the judgment being evaluated is high in idiosyncratic variability, such as attractiveness and familiarity. On the other hand, judgments that are known to have high agreement (i.e., high amounts of shared variance), such as age or masculinity, do not show individualized preferences. Participants judged older and masculine visual representations similarly across model types (i.e., their own model vs. other participants' models).

To determine an optimal number of experimental trials, participants in Exemplary Study 2 complete 1000 trials in chunks of 100 randomized faces. Chunking trials in groups of 100 faces allowed for us to measure the quality of the images produced from an individual's model across each group of 100 stimuli (e.g., after 100 trials, 200 trials, etc.). To compare these models and images, we computed the cosine similarity on both the face image latents and the idiosyncratic visual model latents after each block of 100 trials. The comparison for each cosine similarity score was the participant's final latent vector produced by using data from all 1000 trials.

Visual inspection of the results showed that the cosine similarity of the +6 image latents generally plateau between 300 and 400 trials. However, the cosine similarity of the idiosyncratic model latents increases steadily across all trials. The latter result is not entirely unexpected given how each latent vector is computed. The idiosyncratic model latents are more sensitive to trial-by-trial changes as more novel data is added after each chunk of 100 trials. Thus, the vectors become increasingly more similar to the final vector which includes all data points. On the other hand, the images produced from the +6 image latents vectors are more stable since the vector representing the average of all participants' “neutral” selections are added at each step (refer to equations, above).

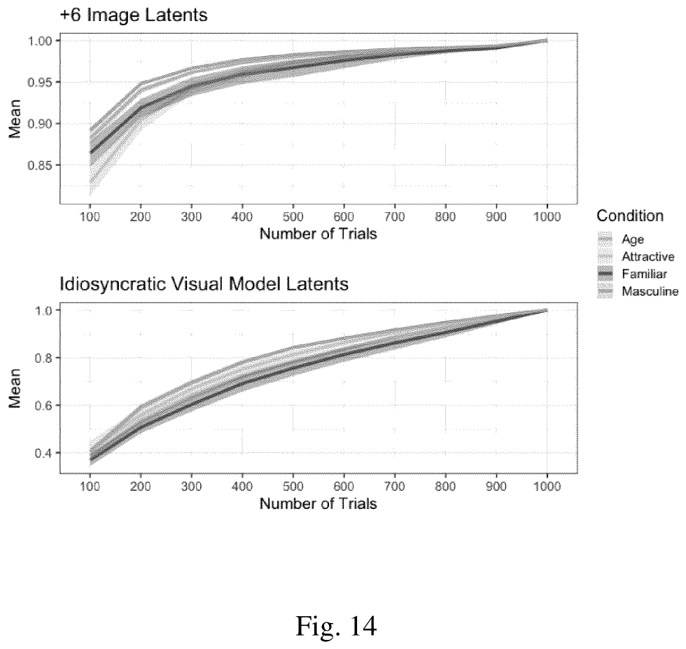

FIG. 14 depicts graphs representing the comparison of cosine similarities between each condition in Exemplary Study 2. The latent vectors at each 100 trials were compared. Visual inspection of the results showed that the cosine similarity of the +6 image latents (top graph depicted in FIG. 14) generally plateau between 300 and 400 trials. However, the cosine similarity of the idiosyncratic model latents (bottom graph depicted in FIG. 14) increases steadily across all trials. The latter result is not entirely unexpected given how each latent vector is computed. The idiosyncratic model latents are more sensitive to trial-by-trial changes as more novel data is added after each chunk of 100 trials. Thus, the vectors become increasingly more similar to the final vector which includes all data points. On the other hand, the images produced from the +6 image latents vectors are more stable since the vector representing the average of all participants' “neutral” selections are added at each step (refer to equations, above).

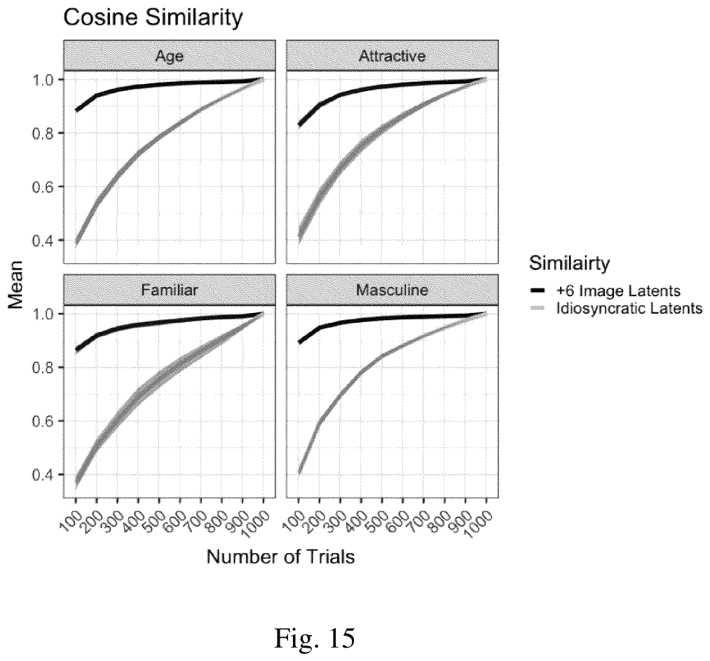

FIG. 15 depicts comparisons of the cosine similarities between the latent vectors of the +6 images (black lines) and the idiosyncratic visual models (gold lines) across all 1000 trials. The latent vectors were compared after each group of 100 trials. The comparison was the latent vectors constructed using data from all 1000 trials. Each panel displays the comparison for one of the judgments in Exemplary Study 2. Shaded areas represent 95% confidence intervals. Directly comparing the cosine similarity of the idiosyncratic model latents and the +6 image latents across each judgment (FIG. 15), it appears that 300 trials is adequate for obtaining stable visual representations from participants' idiosyncratic models. In other words, a minimum of 300 experimental trials (i.e., 300 stimulus categorizations) is required for typical generative reverse correlation studies if the primary goal is to visualize and compute idiosyncratic representations of the social judgment across model values.

### Exemplary Study 3

Studies 1 and 2 provided strong evidence that the generative reverse correlation is capable of visually capturing a diverse set of social judgements that not only appear like the judgement being examined, but are also more predictive of the individual participant's own preferences. Further, the results of Exemplary Study 2 were replicated in Exemplary Study 3, where participants categorized face images sampled directly from the latent space of a new generative model trained exclusively on neutral faces (as described herein). These results suggest that the systems and methods described herein are invariant to the underlying latent space used to generate stimuli, although increasing the diversity of the underlying latent distribution appears to create more diverse idiosyncratic representations while still maintaining psychological alignment.

Exemplary Study 3 tested whether the generative reverse correlation is capable of capturing representations beyond broad social judgments by examining the sensitivity of idiosyncratic visual models to context-dependent evaluations of trustworthiness. For example, the mental prototype of who to trust to watch your child is likely different from the prototype of who to trust to fix your car, despite both being derived from evaluations of “trustworthiness.”

One hundred and forty-six participants (M_{age}=40.22, SD_{age}=10.97) completed the image generation phase of this experiment online through CloudResearch. Participants self-identified as follows: 58 women, 85 men, 1 non-binary, 1 trans (transgender, trans woman, trans man), 1 not reported; 3 Asian, 18 Black, 1 Latinx, 111 White, 12 more than one race, and 1 not reported. Two hundred and sixty participants completed the image judgment phase of this experiment online through CloudResearch. Two participants completed the experiment twice and an additional 11 restarted the experiment; these participants were removed from additional analysis. The remaining 247 participants (M_{age}=43.88, SD_{age}=12.58) self-identified as follows: 123 women, 116 men, 3 non-binary, 2 trans (transgender, trans woman, or trans man), 3 not reported; 1 American Indian/Alaskan Native, 17 Asian, 18 Black, 9 Latinx, 1 Middle Eastern, 1 Native Hawaiian or Other Pacific Islander, 179 White, 1 other, 1 not reported, and 16 more than one race. The stimuli for the image generation phase were the same stimuli used in Exemplary Study 4 and were sampled directly from a newly trained generative model's latent space (see Supporting Information). The images produced by the new model are high-quality face portraits that are primarily neutral in appearance, thus alleviating the concern of an overrepresentation of smiling face stimuli present in the original pretrained model. The images generated from each idiosyncratic visual model were then used in the second phase as stimuli. Twenty-six participants had negative or near zero test-retest reliability (r<0.05) and one participant did not use all three response options at least once. This left us with a final sample of 119 participants across the three conditions: 45 “trust to fix your car”; 43 “trust to watch your child”; and 31 “trust to invest your money.”

In Phase I, participants were randomly assigned to make context-dependent trustworthiness judgments (e.g., who they would trust to “fix their car”, “watch their child”, or “invest their money”). Their judgments were used to create idiosyncratic visual models. In Phase II, a separate group of participants judged the images generated from Phase I participants on how much they trusted each individual depicted to “fix their car,” “watch their child,” or “invest their money.”

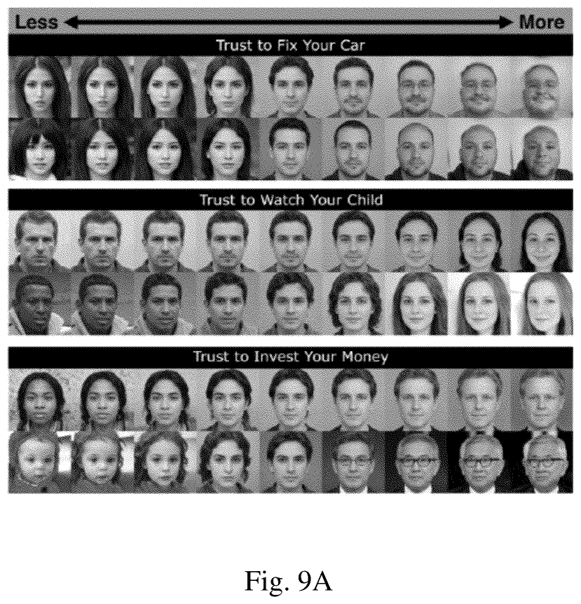

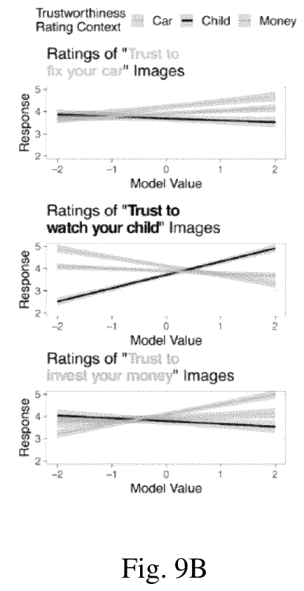

Stimuli in the image judgment phase were images generated from each valid individual participant's model from the image generation phase. For each individual model, images at +/−1 and +/−2 for a total of 476 unique images (4 images×119 participants) were generated. The unique images were judged. FIG. 9A depicts exemplary images generated from idiosyncratic visual models of two participants across each judgment condition. The center image in each row represents the average of all of the latents each participant selected as the “neutral” category. Images to the left and right of the center image represent the linear interpolation at +/−2, 4, 6, and 8, respectively. After removing poor quality participants in Phase II (test-retest r<05; n=26), each of the 476 images was judged on average by 27.86 participants.

FIG. 9B depicts validation results. Each participant judged images generated by their own visual model (yellow lines) and those generated from a random subsample of other participants' visual models (black lines). The x-axis represents the linear interpolation model values and the y-axis represents participants' raw judgment responses. Shaded areas around each line display 95% confidence intervals.

With regard to the “trust to fix your car” images, across all three Phase I conditions, participant ratings were in line with the visual model from which the images were created. Faces manipulated to appear more trustworthy in the car context were perceived as more trustworthy within that context compared to faces manipulated in both “trust to watch your child” and “trust to invest your money” contexts, as evidenced by significant two-way interactions between visual model type and model value (“trust to fix your car” vs. “trust to watch your child”: b=−0.32, t(4620.02)=11.57, p<0.001; “trust to fix your car” vs. “trust to invest your money”: b=−0.11, t(4617.50)=3.97, p<0.001). There was also a significant main effect for “trust to fix your car” images vs. “trust to watch your child” images, b=−0.45, t(217.68)=2.84, p=0.005, but not “trust to fix your car” images vs. “trust to watch your money” images, b=−0.24, t(218.37)=1.54, p=0.126.

Simple slopes analyses for each visual model showed positive and significant slopes for “trust to fix your car” images, b=0.23, t(479)=8.53, p<0.001, and “trust to invest your money” images, b=0.12, t(427)=4.45, p<0.001, and a significant negative slope for “trust to watch your child” images, b=−0.10, t(397)=3.72, p<0.001.

A similar pattern emerged for images manipulated to appear more trustworthy within a “watch your child” context. There was a significant difference in slopes between “trust to watch your child” images and both “trust to fix your car” (b=−0.97, t(4546.11)=37.41, p<0.001) and “trust to invest your money” images (b=−0.71, t(4540.58)=28.54, p<0.001). There was a significant main effect for “trust to watch your child” images vs. “trust to fix your car” images, b=0.43, t(217.84)=2.78, p=0.006, but not “trust to watch your child” images vs. “trust to invest your money” images, b=0.22, t(217.47)=1.46, p=0.145.

Simple slopes analyses for each visual model showed a positive and significant slope for “trust to watch your child” images, b=0.58, t(392)=24.18, p<0.001, and significant negative slopes for “trust to fix your car” images, b=−0.39, t(462)=4.81, p<0.001, and “trust to invest your money” images, b=−0.12, t(382)=5.16, p<0.001.

The pattern was also similar for images manipulated to appear more trustworthy within a “trust to invest your money” context, as indicated in significant differences between the slopes (“trust to invest your money” vs. “trust to fix your car”: b=−0.55, t(3256.21)=17.04, p<0.001; “trust to invest your money” vs. “trust to watch your child”: b=−0.29, t(3241)=8.88, p<0.001). There was also a significant main effect for “trust to invest your money” images vs. “trust to watch your child” images, b=−0.328, t(217.45)=2.14, p=0.034, but not “trust to fix your car” images, b=−0.12, t(216.60)=0.74, p=0.463.

Simple slopes analyses for each visual model showed positive and significant slopes for “trust to invest your money” images, b=0.43, t(282)=14.46, p<0.001, and “trust to fix your car” images, b=0.14, t(343)=4.47, p<0.001, but a significant negative slope for “trust to watch your child” images, b=−0.12, t(319)=3.85, p<0.001.

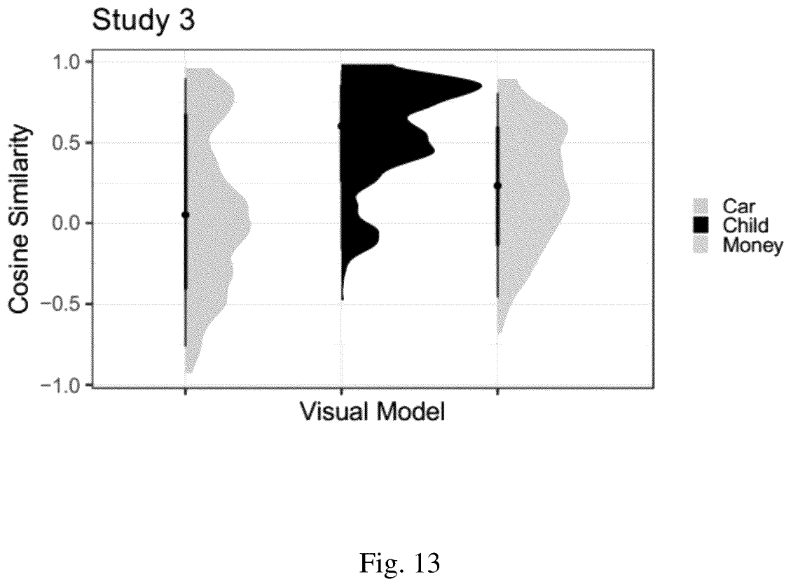

FIG. 13 depicts cosine similarity between all three context-dependent trustworthiness conditions in Exemplary Study 3. The cosine similarity (y-axis) was calculated by taking the average similarity of each participant's idiosyncratic visual model and every other participant's visual model within a particular judgment category (x-axis; colored distributions).

Like the previous studies, the average cosine similarity of each participant's idiosyncratic visual model was significantly correlated with their test-retest correlation (car: r(43)=0.31, p=0.045; child: r(41)=0.36, p=0.018; money: r(29)=0.39, p=0.031).

Similarity scores were computed to assess whether the visual models were significantly different from one another. The average cosine similarity of “trust to fix your car” visual models was significantly lower than both “trust to watch your child” visual models (t(116)=13.35, p<0.001, d=2.85) and “trust to invest your money” visual models (t(116)=3.67, p<0.001, d=0.85). Similarly, the “trust to watch your child” visual models were significantly higher than the “trust to invest your money” visual models, t(116)=8.45, p<0.001, d=1.99.

Supplementary Table 7 is a linear-mixed effects regression table for Exemplary Study 3 “trust to fix your car” ratings. The “Visual Model 1” predictor variable compares images generated from “trust to fix your car” visual models to images generated from “trust to watch your child” visual models. The “Visual Model 2” predictor variable compares images generated from “trust to fix your car” visual models to images generated from “trust to invest your money” visual models. The “Model Value” variable (i.e., the image linear interpolation value) ranged from −2 to +2 in increments of one and was treated as a continuous predictor. The model included random intercepts for each participant and face image.

Supplementary Table 8 is a linear-mixed effects regression table for Exemplary Study 3 “trust to watch your child” ratings. The “Visual Model 1” predictor variable compares images generated from “trust to watch your child” visual models to images generated from “trust to watch fix your car” visual models. The “Visual Model 2” predictor variable compares images generated from “trust watch your child” visual models to images generated from “trust to invest your money” visual models. The “Model Value” variable (i.e., the image linear interpolation value) ranged from −2 to +2 in increments of one and was treated as a continuous predictor. The model included random intercepts for each participant and face image.

Supplemental Table 9 is a linear-mixed effects regression table for Exemplary Study 3 “trust to invest your money” ratings. The “Visual Model 1” predictor variable compares images generated from “trust to invest your money” visual models to images generated from “trust to watch your child” visual models. The “Visual Model 2” predictor variable compares images generated from “trust invest your money” visual models to images generated from “trust to fix your car” visual models. The “Model Value” variable (i.e., the image linear interpolation value) ranged from −2 to +2 in increments of one and was treated as a continuous predictor. The model included random intercepts for each participant and face image. Previous research on modeling of judgments has focused almost exclusively on gestalt social judgments (e.g., judging “trustworthiness” or “attractiveness” without further context), rather than on situation- or context-dependent social judgments. As such, the systems and methods described herein are a way to accurately capture visual representations that are highly sensitive and context dependent.

### Exemplary Study 4

The objective of Exemplary Study 4 was to test generative reverse correlation with stimuli sampled from a larger, more heterogeneous latent space trained on expressively neutral face images. Importantly, if generative reverse correlation is robust, valid, and generalizable, the results should be invariant to the underlying model and latent space used to create the stimuli.

The method for this study were nearly identical to those of Exemplary Study 2. We had participants categorize faces randomly generated from a latent space that was trained on faces that were only neutral in appearance. As before, we selected two types of judgments to focus on: “feminine-masculine” as the highly shared judgment and “unattractive-attractive” as the highly idiosyncratic judgment. After categorization, we constructed idiosyncratic visual models for each participant and had them return to rate images manipulated by their own model and images manipulated from a random selection of other participants' models. One hundred and twenty-four participants took this study online through CloudResearch. Like Exemplary Study 2, we only included in the analyses participants who completed the study in its entirety and did not restart. This left us with a final sample of 115 participants across each condition: feminine/masculine=58; un/attractive=57.

Participants (M_{age}=42.06, SD_{age}=11.27) self-identified as follows: 44 women, 68 men, 1 non-binary, 1 trans (transgender, trans man, trans woman); 1 American Indian/Alaskan Native, 5 Asian, 11 Black, 4 Latinx, 84 White, 9 more than one race, and 1 other/not reported. Out of the 115 usable participants in Phase I (image model construction), 96 returned for the image rating component (Phase II). One participant completed the survey twice and their data was removed from analyses. Additionally, four participants had negative or near zero test-retest reliabilities (r<0.05) in Phase I. However, none of these participants completed Phase II, so their data did not affect subsequent analyses. This left a final sample of 97 participants across both conditions for Phase II: 45 for feminine/masculine and 51 for un/attractiveness. In order to generate high-quality, neutral-appearing face stimuli, we fine-tuned the StyleGAN-2 FFHQ model with a set of 47,724 high quality neutral faces (over 75,000 training images with augmentation). We trained the new GAN for an additional 4,000 epochs reaching a final Fréchet inception distance score of 4.19, which is comparable to the original StyleGAN-2 FFHQ model trained on 70,000 face images (see previous section for additional details).

In order to select the stimuli that participants saw, we first randomly generated a large set of face images from the new model (>1000). Next, we manually inspected the images and removed any faces that contained artifacts or were clearly warped. Based on a secondary analysis performed on Exemplary Study 2's data (see Exemplary Study 2 Additional Results in this document), we concluded that 300 image trials were enough to obtain stable visualizations from participants' idiosyncratic visual model vectors. Thus, we selected the first 300 images out of the remaining pool to act as stimuli in the experiment.

FIG. 9A depicts exemplary images generated from idiosyncratic visual models of two participants across conditions. The middle image represents the average of all faces participants categorized as “unsure”. Each image to the right and left of the middle represents a +/−1 model interpolation step value, respectively. The second example participant's visual model in the feminine-masculine condition (second row from top) shows an example of a model going out-of-bounds at the extremes (greater than +/−3).

The participant procedure was nearly identical to Exemplary Study 2 with three minor differences. First, instead of 1000 trials, participants completed 300 trials. Second, we elected to only examine and validate two judgments: femininity/masculinity and attractiveness. Finally, during the validation phase of the study (i.e., Phase II), participants judged visual representations from their own and other's idiosyncratic models at values of +/−1, +/−2, and 0. We reduced the model interpolation value range because images constructed at higher values quickly degraded in quality for some attributes and participants (i.e., the idiosyncratic latent space went out of sample).

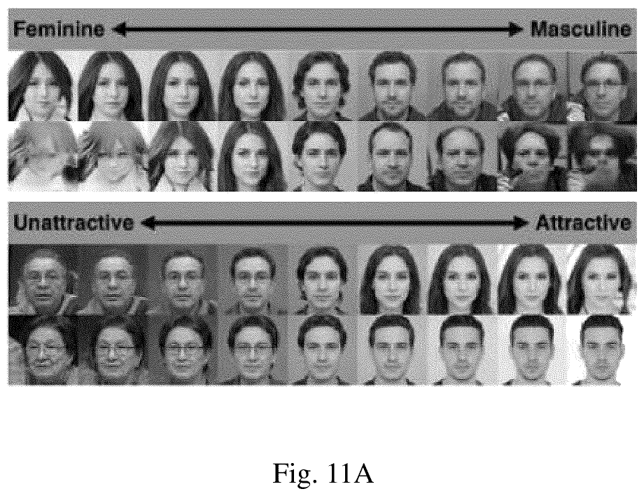

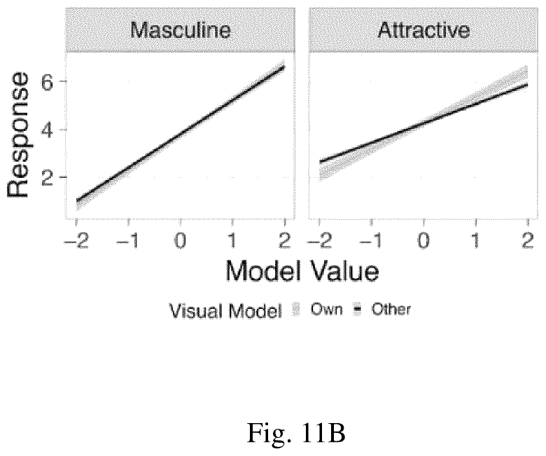

FIG. 11B depicts the validation results of Exemplary Study 4. Each participant judged images generated from their own visual model (yellow lines) and those generated from a random subsample of other participants' visual models (black lines). The x-axis represents the model interpolation values and the y-axis represents participants' responses. Shaded areas around each line display 95% confidence intervals. As before, we replicated Studies 1 and 2 showing that the average similarity of feminine-masculine visual models was significantly higher than the average similarity of attractiveness visual models, t(116.3)=8.23, p<0.001, d=1.50.

Regarding ratings of masculinity, as in Exemplary Study 2, participants rated the images manipulated by the models to appear more “masculine” as more masculine, b=1.47, t(26)=6.22, p<0.001. There was no main effect of visual model type (participant's own model vs. other participants' models), b=0.05, t(26)=0.15, p=0.879, or an interaction, b=0.06, t(26)=0.22, p=0.831.

Cosine similarity scores were correlated with participants' test-retest reliability for both feminine-masculine visual models (r(56)=0.50, p<0.001), as well as attractiveness visual models (r(54)=0.59, p<0.001). These correlations were not significantly different from one another, z=−0.64, p=0.518. While the highly shared visual models do not show a more significant correlation with test-retest reliability (i.e., theoretically replicating Studies 1 and 2), this may be due to the greater range of cosine values across participants in this sample. One potential explanation for the increase in cosine similarity scores in both feminine-masculine and attractiveness visual models may be the new latent space used in this study.

FIG. 13 depicts a distribution of the cosine similarities for Exemplary Studies 1, 2, and 4 (Panels A-C, respectively). The cosine similarity (y-axis) was calculated by taking the average similarity of each participant's idiosyncratic visual model and every other participant's visual model within a particular judgment category (x-axis; colored distributions). Across all studies, we predicted that the similarity for highly shared judgments (e.g., feminine-masculine, age) would be larger than highly idiosyncratic judgments (e.g., trustworthy, attractive). Error bars represent 95% confidence intervals.

Supplementary Table 10 is a linear-mixed effects regression table for Exemplary Study 4 “masculinity” ratings. The “Visual Model” predictor variable compares images generated from other participants' visual models to images generated from participants' own visual model. The “Model Value” variable (i.e., the image linear interpolation value) ranged from −2 to +2 in increments of one and was treated as a continuous predictor. The model included random intercepts for each participant and face image.

Regarding ratings of attractiveness, participants rated the images manipulated by the models to appear more “attractive” as more attractive, b=1.09, t(26)=11.15, p<0.001. There was no main effect of visual model type (own vs. other), b=−0.02, t(26)=0.11, p=0.911, but there was a significant interaction, b=0.28, t(26)=2.59, p=0.016. Participants' judgments were more sensitive to their own visual models (b=1.09) than to other participants' visual models (b=0.82).

Supplementary Table 11 is a linear-mixed effects regression table for the Supplemental Study “attractiveness” ratings. The “Visual Model” predictor variable compares images generated from other participants' visual models to images generated from participants' own visual model. The “Model Value” variable (i.e., the image linear interpolation value) ranged from −2 to +2 in increments of one and was treated as a continuous predictor. The model included random intercepts for each participant and face image.

Together, these results replicate those in Exemplary Study 2 but with one important insight: generative reverse correlation appears to be invariant to the underlying latent space. Our previous method required projecting real neutral faces into a pretrained model's latent space in order to have a robust stimulus set that was not oversaturated with smiling faces. However, this approach limited the diversity of the stimuli generated. To address this, we trained a new model using nearly 48,000 faces with neutral appearance. The resulting model is able to create a diverse range of novel faces with neutral expressions. Overall, the results from this study replicated the results from Exemplary Study 2: Participants' own visual models of attractiveness (but not femininity-masculinity) were more predictive of their subsequent judgments.

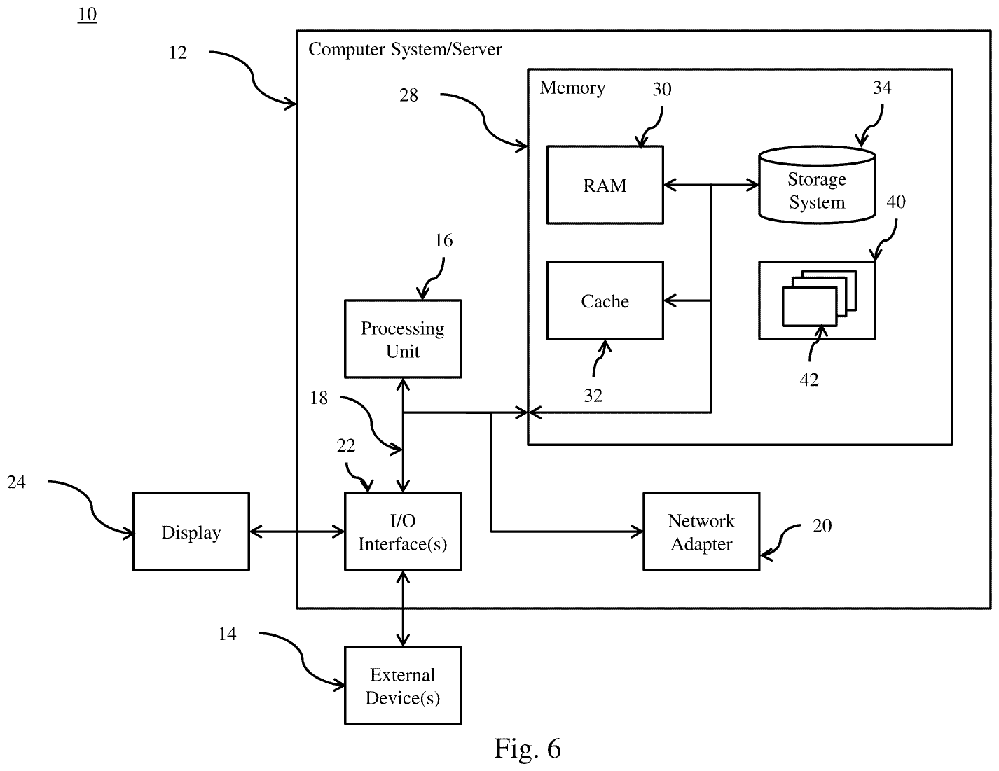

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove. In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block diagrams may occur out of the order noted in the figures. For example, two blocks shown in succession may, in fact, be executed substantially concurrently, or the blocks may sometimes be executed in the reverse order, depending upon the functionality involved. In some alternative implementations, one or more of the functions noted in the block diagrams may not be performed and/or one or more other functions may be performed. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

SUPPLEMENTARY TABLE 1
Linear-Mixed Effects Regression Table For Exemplary
Study 1 “Masculinity” Ratings

| | Ratings of Masculinity | | | | |
|---|---|---|---|---|---|
| | Estimates | CI | Statistic | p | df |
| Predictors | | | | | |
| (Intercept) | 3.9 | 3.73-4.13 | 38.96 | <0.001 | 181.69 |
| Visual Model | 0.83 | 0.61-1.05 | 7.39 | <0.001 | 255.89 |
| Model Value | 0.63 | 0.58-0.67 | 25.95 | <0.001 | 258.20 |
| Visual Model × | −0.96 | −1.03-−0.89 | −27.14 | <0.001 | 256.14 |
| Model Value | | | | | |
| Random Effects | | | | | |
| σ2 | 1.16 | | | | |
| T00 face | 0.75 | | | | |
| T00 participant | 0.22 | | | | |
| ICC | 0.45 | | | | |
| N participant | 50 | | | | |
| N face | 260 | | | | |
| Observations | 5140 | | | | |
| Marginal R²/ | 0.562/ | | | | |
| Conditional R² | 0.761 | | | | |

SUPPLEMENTARY TABLE 2
Linear-Mixed Effects Regression Table For Exemplary
Study 1 “Trustworthiness” Ratings

| | Ratings of Trustworthiness | | | | |
|---|---|---|---|---|---|
| | Estimates | CI | Statistic | p | df |
| Predictors | | | | | |
| (Intercept) | 4.65 | 4.42-4.88 | 40.09 | <0.001 | 49.57 |
| Visual Model | −0.46 | −0.56-−0.36 | −9.08 | <0.001 | 260.56 |
| Model Value | −0.11 | −0.13-−0.09 | −9.98 | <0.001 | 268.64 |
| Visual Model × | 0.32 | 0.29-0.35 | 19.94 | <0.001 | 260.01 |
| Model Value | | | | | |
| Random Effects | | | | | |
| σ2 | 1.05 | | | | |
| T00 face | 0.10 | | | | |
| T00 participant | 0.54 | | | | |
| ICC | 0.38 | | | | |
| N participant | 44 | | | | |
| N face | 260 | | | | |
| Observations | 4546 | | | | |
| Marginal R²/ | 0.160/ | | | | |
| Conditional R² | 0.478 | | | | |

SUPPLEMENTARY TABLE 3
Linear-Mixed Effects Regression Table For Exemplary
Study 2 “Agedness” Ratings

| | Ratings of “Old” (Age) | | | | |
|---|---|---|---|---|---|
| | Estimates | CI | Statistic | p | df |
| Predictors | | | | | |
| (Intercept) | 3.97 | 3.67-4.26 | 27.03 | <0.001 | 75.05 |
| Visual Model | 0.01 | −0.22-0.24 | 0.07 | 0.948 | 50.08 |
| Model Value | 0.48 | 0.42-0.54 | 16.53 | <0.001 | 50.18 |
| Visual Model × | −0.05 | −0.12-0.01 | −1.59 | 0.117 | 50.14 |
| Model Value | | | | | |
| Random Effects | | | | | |
| σ² | 0.99 | | | | |
| t00 image | 0.07 | | | | |
| t00 participant | 0.36 | | | | |
| ICC | 0.30 | | | | |
| N participant | 34 | | | | |
| N image | 54 | | | | |
| Observations | 1870 | | | | |
| Marginal R²/ | 0.633/ | | | | |
| Conditional R² | 0.745 | | | | |

SUPPLEMENTARY TABLE 4
Linear-Mixed Effects Regression Table For Exemplary
Study 2 “Masculinity” Ratings

| | Ratings of Masculinity | | | | |
|---|---|---|---|---|---|
| | Estimates | CI | Statistic | p | df |
| Predictors | | | | | |
| (Intercept) | 3.98 | 3.52-4.45 | 16.70 | <0.001 | 55.02 |
| Visual Model | 0.02 | −0.47-0.52 | 0.10 | 0.923 | 50.00 |
| Model Value | 0.55 | 0.43-0.68 | 8.47 | <0.001 | 50.00 |
| Idiosyncratic × Model Value | 0.00 | −0.14-0.14 | 0.05 | 0.958 | 50.00 |
| Random Effects | | | | | |
| σ2 | 0.66 | | | | |
| t00 image | 0.47 | | | | |
| t00 participant | 0.09 | | | | |
| ICC | 0.46 | | | | |
| N participant | 33 | | | | |
| N image | 54 | | | | |
| Observations | 1836 | | | | |
| Marginal R²/ | 0.763/ | | | | |
| Conditional R² | 0.872 | | | | |

SUPPLEMENTARY TABLE 5
Linear-Mixed Effects Regression Table For Exemplary
Study 2 “Attractiveness” Ratings

| | Ratings of Attractiveness | | | | |
|---|---|---|---|---|---|
| | Estimates | CI | Statistic | p | df |
| Predictors | | | | | |
| (Intercept) | 3.95 | 3.53-4.37 | 18.52 | <0.001 | 35.38 |
| Visual Model | −0.19 | −0.41-0.03 | −1.71 | 0.087 | 49.83 |
| Model Value | 0.45 | 0.40-0.51 | 15.91 | <0.001 | 49.31 |
| Visual Model × | −0.18 | −0.24-−0.12 | −5.76 | <0.001 | 49.38 |
| Model Value | | | | | |
| Random Effects | | | | | |
| σ2 | 1.20 | | | | |
| t00 image | 0.04 | | | | |
| t00 participant | 0.85 | | | | |
| ICC | 0.43 | | | | |
| N participant | 24 | | | | |
| N image | 54 | | | | |
| Observations | 1322 | | | | |

SUPPLEMENTARY TABLE 6
Linear-Mixed Effects Regression Table For Exemplary
Study 2 “Familiarity” Ratings

| | Ratings of Familiarity | | | | |
|---|---|---|---|---|---|
| | Estimates | CI | Statistic | p | df |
| Predictors | | | | | |
| (Intercept) | 4.39 | 3.68-5.11 | 12.06 | <0.001 | 23.27 |
| Visual Model | −0.18 | −0.47-0.11 | −1.20 | 0.230 | 50.00 |
| Model Value | 0.21 | 0.14-0.29 | 5.57 | <0.001 | 50.00 |
| Visual Model × | −0.20 | −0.28-−0.12 | −4.86 | <0.001 | 50.00 |
| Model Value | | | | | |
| Random Effects | | | | | |
| σ2 | 1.84 | | | | |
| t00 image | 0.08 | | | | |
| t00 participant | 2.17 | | | | |
| ICC | 0.55 | | | | |
| N participant | 19 | | | | |
| N image | 54 | | | | |
| Observations | 1134 | | | | |
| Marginal R²/ | 0.024/ | | | | |
| Conditional R² | 0.561 | | | | |

SUPPLEMENTARY TABLE 7
Linear-Mixed Effects Regression Table For Exemplary
Study 3 “Trust To Fix Your Car” Ratings

| | Ratings of “Trust to Fix Your Car” Images | | | | |
|---|---|---|---|---|---|
| | Estimates | CI | Statistic | p | df |
| Predictors | | | | | |
| (Intercept) | 4.15 | 3.92-4.38 | 35.03 | <0.001 | 334.60 |
| Visual Model 1 [Car vs. Child] | −0.45 | −0.76-−0.14 | −2.84 | 0.005 | 258.77 |
| Visual Model 2 [Car vs. Money] | −0.24 | −0.55-0.07 | −1.54 | 0.126 | 218.38 |
| Model Value | 0.23 | 0.18-0.28 | 8.53 | <0.001 | 479.07 |
| Visual Model 1 × Model Value | −0.32 | −0.38-−0.27 | −11.57 | <0.001 | 5186.95 |
| Visual Model 2 × Model Value | −0.11 | −0.17-−0.06 | −3.97 | <0.001 | 4617.50 |
| Random Effects | | | | | |
| σ2 | 1.46 | | | | |
| T00 participant | 0.81 | | | | |
| T00 face | 0.13 | | | | |
| ICC | 0.39 | | | | |
| N participant | 221 | | | | |
| N face | 180 | | | | |
| Observations | 4913 | | | | |
| Marginal R²/Conditional R² | 0.037/0.414 | | | | |

SUPPLEMENTARY TABLE 8
Linear-Mixed Effects Regression Table For Exemplary Study
3 “Trust to Watch Your Child” Ratings

| | Ratings of “Trust to Watch Your Child” Images | | | | |
|---|---|---|---|---|---|
| | Estimates | CI | Statistic | p | df |
| Predictors | | | | | |
| (Intercept) | 3.68 | 3.47-3.89 | 34.01 | <0.001 | 243.13 |
| Visual Model 1 [Child vs. Car] | 0.43 | 0.12-0.73 | 2.78 | 0.006 | 217.86 |
| Visual Model 2 [Child vs. Money] | 0.22 | −0.07-0.51 | 1.46 | 0.145 | 217.47 |
| Model Value | 0.58 | 0.54-0.63 | 24.18 | <0.001 | 392.39 |
| Visual Model 1 × Model Value | −0.97 | −1.02-−0.92 | −37.41 | <0.001 | 4546.11 |
| Visual Model 2 × Model Value | −0.71 | −0.76-−0.66 | −28.54 | <0.001 | 4540.58 |
| Random Effects | | | | | |
| σ2 | 1.23 | | | | |
| T00 participant | 0.79 | | | | |
| T00 face | 0.12 | | | | |
| ICC | 0.42 | | | | |
| N participant | 221 | | | | |
| N face | 172 | | | | |
| Observations | 4844 | | | | |
| Marginal R²/Conditional R² | 0.176/0.525 | | | | |

SUPPLEMENTARY TABLE 9
Linear-Mixed Effects Regression Table For Exemplary Study
3 “Trust to Invest Your Money” Ratings

| | Ratings of “Trust to Invest Your Money” | | | | |
|---|---|---|---|---|---|
| | Estimates | CI | Statistic | p | df |
| Predictors | | | | | |
| (Intercept) | 4.08 | 3.86-4.30 | 36.22 | <0.001 | 248.31 |
| Visual Model 1 [Money vs. Child] | −0.33 | −0.63-−0.03 | −2.14 | 0.034 | 217.45 |
| Visual Model 2 [Money vs. Car] | −0.12 | −0.43-0.20 | −0.73 | 0.463 | 216.60 |
| Model Value | 0.43 | 0.37-0.49 | 14.46 | <0.001 | 281.61 |
| Visual Model 1 × Model Value | −0.55 | −0.61-−0.49 | −17.04 | <0.001 | 3256.21 |
| Visual Model 2 × Model Value | −0.29 | −0.36-−0.23 | −8.88 | <0.001 | 3241.00 |
| Random Effects | | | | | |
| σ2 | 1.44 | | | | |
| T00 participant | 0.82 | | | | |
| T00 face | 0.12 | | | | |
| ICC | 0.40 | | | | |
| N participant | 221 | | | | |
| N face | 124 | | | | |
| Observations | 3503 | | | | |
| Marginal R²/Conditional R² | 0.082/0.445 | | | | |

SUPPLEMENTARY TABLE 10
Linear-Mixed Effects Regression Table For Exemplary
Study 4 “Masculinity” Ratings

| | Ratings of Masculinity | | | | |
|---|---|---|---|---|---|
| | Estimates | CI | Statistic | p | df |
| Predictors | | | | | |
| (Intercept) | 3.76 | 3.06-4.45 | 11.11 | <0.001 | 27.41 |
| Visual Model | 0.06 | −0.70-0.81 | 0.15 | 0.879 | 26.00 |
| Model Value | 1.47 | 0.98-1.95 | 6.22 | <0.001 | 26.00 |
| Visual Model × Model Value | −0.06 | −0.59-0.48 | −0.22 | 0.831 | 26.00 |
| Random Effects | | | | | |
| σ2 | 1.10 | | | | |
| T00 participant2 | 0.14 | | | | |
| T00 face | 0.53 | | | | |
| ICC | 0.38 | | | | |
| N participant | 45 | | | | |
| N face | 30 | | | | |
| Observations | 1350 | | | | |
| Marginal R²/Conditional R² | 0.695/0.810 | | | | |

SUPPLEMENTARY TABLE 11
Linear-Mixed Effects Regression Table For Exemplary
Study 4 “Attractiveness” Ratings

| | Ratings of Attractiveness | | | | |
|---|---|---|---|---|---|
| | Estimates | CI | Statistic | p | df |
| Predictors | | | | | |
| (Intercept) | 4.27 | 3.90-4.65 | 22.58 | <0.001 | 62.84 |
| Visual Model | −0.02 | −0.33-0.30 | −0.11 | 0.911 | 26.00 |
| Model Value | 1.09 | 0.89-1.30 | 11.15 | <0.001 | 26.00 |
| Visual Model × Model Value | −0.28 | −0.50-−0.06 | −2.59 | 0.015 | 26.00 |
| Random Effects | | | | | |
| σ2 | 1.50 | | | | |
| T00 participant | 0.85 | | | | |
| T00 face | 0.07 | | | | |
| ICC | 0.38 | | | | |
| N participant | 51 | | | | |
| N face | 30 | | | | |
| Observations | 1530 | | | | |
| Marginal R²/Conditional R² | 0.385/0.618 | | | | |

What is claimed is:

1. A method of constructing a customized generative model, comprising:
reading a plurality of synthetic images and associated latent representations;
presenting each of the plurality of synthetic images to one or more users via a client computing platform;
reading a plurality of inputs to the client computing platform, the plurality of inputs characterizing a plurality of values for associated attributes of each of the plurality of synthetic images; and
based on the values of the associated attributes and the latent representations, training a regression model to predict the values of the attributes from the latent representations.

2. The method of claim 1, further comprising:
receiving target values for the plurality of attributes;
using the regression model, determining a target latent representation corresponding to the target values; and
providing the target latent representation to a generative model and receiving therefrom an image embodying the target values for the plurality of attributes.

3. The method of claim 1, wherein each of the plurality of synthetic images was generated by a generative model based on its associated latent representation.

4. The method of claim 1, further comprising:
generating the plurality of synthetic images by a generative model.

5. The method of claim 3, wherein generating the plurality of synthetic images comprises selecting randomly from a latent space of the generative model.

6. The method of claim 3, further comprising:
pretraining the generative model on a single object type.

7. The method of claim 3, further comprising:
training the generative model using a training dataset comprising neutral-appearing images.

8. The method of claim 1, further comprising:
generating the associated latent representation of each synthetic image by providing the synthetic image to an encoder.

9. The method of claim 7, wherein the encoder comprises an artificial neural network.

10. The method of claim 1, wherein the plurality of synthetic images is presented to exactly one user, thereby customizing the regression model to the exactly one user.

11. The method of claim 1, wherein the plurality of synthetic images is presented to a plurality of users, thereby customizing to a group comprising the plurality of users.

12. The method of claim 1, wherein each value is selected from a positive, neutral, and negative value.

13. The method of claim 1, wherein the value is a scalar intensity value.

14. The method of claim 1, wherein the regression model comprises a linear regression.

15. The method of claim 1, wherein the generative model is a generative adversarial network (GAN).

16. The method of claim 1, wherein the latent representation is a tensor.

17. A method of constructing a customized generative model, comprising:
reading a plurality of synthetic images and associated latent representations;
presenting each of the plurality of synthetic images to a user via a client computing platform;
reading a plurality of inputs to the client computing platform, the plurality of inputs characterizing a plurality of values for associated attributes of each of the plurality of synthetic images; and
determining a plurality of summary latent representations, each corresponding to a unique value of the plurality of associated attributes.

18. The method of claim 16, further comprising:
receiving target values for the plurality of attributes;
selecting summary latent representations from the plurality of summary latent representations corresponding to the received target values;
providing the selected summary latent representations to a generative model and receiving therefrom an image embodying the target values for the plurality of attributes.

19. The method of claim 16, wherein determining each summary latent representation comprises averaging the latent representations of each synthetic image having the unique value.

20. A computer program product for constructing a customized generative model, the computer program product comprising a computer readable storage medium having program instructions embodied therewith, the program instructions executable by a processor to cause the processor to:
read a plurality of synthetic images and associated latent representations;
present each of the plurality of synthetic images to one or more users via a client computing platform;
reading a plurality of inputs to the client computing platform, the plurality of inputs characterizing a plurality of values for a plurality of associated attributes of each of the plurality of synthetic images; and
based on the values of the associated attributes and the latent representations, train a regression model to predict the values of the attributes from the latent representations.

21. A method of generating a synthetic image, the method comprising:
reading an input image;
encoding the input image into a latent representation in a latent space;
reading target values for one or more image attributes;
modifying the latent representation to conform with the target values using a regression model, the regression model relating locations in the latent space to values of the one or more image attributes, thereby generating a modified latent representation in the latent space conforming with the target values;
providing the modified latent representation to an image generator; and
reading a synthetic image generated by the image generator, the synthetic image embodying the target values.

22. The method of claim 20, wherein the regression model was constructed by:
reading a plurality of synthetic images and associated latent representations;
presenting each of the plurality of synthetic images to one or more users via a client computing platform;
reading a plurality of inputs to the client computing platform, the plurality of inputs characterizing a plurality of values for a plurality of associated attributes of each of the plurality of synthetic images; and
based on the values of the associated attributes and the latent representations, training a regression model to predict the values of the attributes from the latent representations.

23. A method of generating a synthetic image, the method comprising:
reading an input image;
encoding the input image into a latent representation in a latent space;
reading target values for one or more image attributes;
modifying the latent representation to conform with the target values by adjusting the latent representation according to one or more summary latent representations corresponding to the target values, thereby generating a modified latent representation in the latent space conforming with the target values;
providing the modified latent representation to an image generator; and
reading a synthetic image generated by the image generator, the synthetic image embodying the target values.

24. The method of claim 23, wherein the summary latent representations were constructed by:
reading the target values for the one or more image attributes;
selecting summary latent representations from the plurality of summary latent representations corresponding to the received target values;
providing the selected summary latent representations to a generative model; and
receiving therefrom an image embodying the target values for the plurality of attributes.
